(19) United States
(12) Patent Application Publication
(10) Pub. No.: US 2006/0204794 A1
(43) Pub. Date: Sep. 14, 2006

(54) Laminate structure, magnetic recording medium and method for producing the same, magnetic recording device, magnetic recording method, and element with the laminate structure

(75) Inventors: Hideyuki Kikuchi, Kawasaki (JP); Ken-ichi Itoh, Kawasaki (JP); Hideki Masuda, Tokyo (JP)

Correspondence Address: Patrick G. Burns;GREER, BURNS & CRAIN, LTD., 300 South Wacker Drive, Suite 2500, Chicago, IL, 60606, US

(73) Assignees: FUJITSU LIMITED; KANAGAWA ACADEMY OF SCIENCE AND TECHNOLOGY.

(21) Appl. No.: 11/222,510

(22) Filed: Sep. 8, 2005

(30) Foreign Application Priority Data
Sep. 9, 2004 (JP) 2004-262861

(51) Int. Cl. G11B 5/66; B32B 5/16

(52) U.S. Cl. 428/836.2; 428/328; 428/702; 428/836.3; 428/832

(57) ABSTRACT

The objects of the present invention is to provide laminate structures that are adapted widely in a wide range of fields such as magnetic recording media, nonvolatile memories, giant magneto resistance elements, spin valve films, tunnel effect films, various sensors, displays, and optical elements; high-quality magnetic recording media that can perform high-density recording and high-velocity recording with higher capacity without increasing write current at magnetic heads, in particular exhibit excellent overwrite properties, uniform properties, in particular superior saturation magnetization (tBr) and the anisotropy field (Hd), and the like. The laminate structure of the present invention contains a number of metal nanopillars and plural insulating layers, wherein the lengths of the metal nanopillars are approximately equivalent, each of the plural insulating layers is penetrated by the metal nanopillars, and the plural insulating layers are laminated to each other. The magnetic recording medium of the present invention contains the laminate structure on the substrate, and the metal nanopillars formed of a magnetic material extend to a direction approximately perpendicular to the surface of the substrate.

### CROSS-REFERENCE TO RELATED APPLICATIONS

This application is based upon and claims the benefit of priority from the prior Japanese Patent Application No. 2004-262861, filed on Sep. 9, 2004, the entire contents of which are incorporated herein by reference.

### BACKGROUND OF THE INVENTION

1. Field of the Invention

The present invention relates to a laminate structure, having metal nanopillars and being utilized widely such as for magnetic recording media, nonvolatile memories, giant magneto resistance elements, spin valve films, tunnel effect films, various sensors, displays, and optical elements; a magnetic recording medium, equipped with the laminate structure and capable of high-speed recording with larger capacity, and applied to hard disk devices utilized in various products such as external memory devices of computers and recording devices of public videos; a method for producing the magnetic recording medium with higher efficiency and lower cost; a magnetic recording device and a magnetic recording method that utilize the magnetic recording medium in vertical recording manner; and an element, equipped with the laminate structure and properly utilized for nonvolatile memories, giant magneto resistance elements, spin valve films, tunnel effect films, various sensors, displays, and optical elements.

2. Description of the Related Art

With technological innovations in information technology industries, demands have been made to provide magnetic recording media which have a large capacity, enable high-speed recording and thus to increase the recording density in such magnetic recording media and are available at lower cost. It has been attempted to increase the recording density in a magnetic recording medium by horizontally recording information on a continuous magnetic film in the medium. However, the related technology may almost have saturated. When crystal grains of magnetic particles constituting the continuous magnetic film have a large size, a complex magnetic domain structure is formed to thereby increase noise. In contrast, when the magnetic particles have a small size to avoid increased noise, the magnetization tends to decrease with time due to thermalfluctuation, thus inviting errors. In addition, a demagnetizing field for recording relatively increases with an increasing recording density of the magnetic recording medium. Thus, the magnetic recording medium must have an increased coercive force and do not have sufficient overwrite properties due to insufficient writing ability of a recording head.

Recently, considerable efforts have been made to develop an advanced recording system in place of the horizontal recording system. One of them is a recording system using a patterned magnetic recording medium, in which a magnetic film in the medium is not a continuous film but is in the pattern of, for example, dot, bar or pillar on the order of nanometers and thereby constitutes not a complex magnetic domain structure but a single domain structure (e.g., S. Y. Chou Proc. IEEE 85 (4), 652 (1997)). Another is a perpendicular recording system, in which a recording demagnetization field is smaller and information can be recorded at a higher density than in the horizontal recording system, the recording layer can have a somewhat large thickness and the recording magnetization is resistant to thermalfluctuations (e.g., Japanese Patent Application Laid-Open (JP-A) No. 06-180834). On the perpendicular recording system, JP-A No. 52-134706 proposes a combination use of a soft-magnetic film and a perpendicularly magnetized film. However, this technique is insufficient in writing ability with a single pole head. To avoid this problem, JP-A No. 2001-283419 proposes a magnetic recording medium further comprising a soft-magnetic underlayer. Such magnetic recording on a magnetic recording medium according to the perpendicular recording system is illustrated in FIG. 1. A read-write head (single pole head) 100 of perpendicular-magnetic-recording system has a main pole 102 facing a recording layer 14 of the magnetic recording medium. The magnetic recording medium comprises a substrate, soft-magnetic layer 13, an intermediate layer (nonmagnetic layer) 15 and a recording layer (perpendicularly magnetized film) 14 arranged in this order. The main pole 102 of the read-write head (single pole head) 100 supplies a recording magnetic field toward the recording layer (perpendicularly magnetized film) 14 at a high magnetic flux density. The recording magnetic field flows from the recording layer (perpendicularly magnetized film) 14 via the soft-magnetic layer 13 to a latter half portion 104 of the read-write head 100 to form a magnetic circuit. The latter half portion 104 has a portion facing the recording layer (perpendicularly magnetized film) 14 with a large size, and thereby its magnetization does not affect the recording layer (perpendicularly magnetized film) 14. The soft-magnetic layer 13 in the magnetic recording medium also has the same function as the read-write head (single pole head) 100.

However, the soft-magnetic layer 13 focuses not only the recording magnetic field supplied from the read-write head (single pole head) 100 but also a floating magnetic field leaked from surroundings to the recording layer (perpendicularly magnetized film) 14 to thereby magnetize the same, thus inviting increased noise in recording. The patterned magnetic film requires complicated patterning procedures and thus is expensive. In the magnetic recording medium having the soft-magnetic underlayer, the soft-magnetic underlayer must be arranged at a close distance from the single pole head in magnetic recording. Otherwise, a magnetic flux extending from the read-write head (single pole head) 100 to the soft-magnetic underlayer 12 diverge with an increasing distance between the two components, and information is recorded in a broadened magnetic field with larger bits in the lower part of the recording layer (perpendicularly magnetized film) 14 arranged on the soft-magnetic underlayer 12 (see FIGS. 2A and 2B). In this case, the read-write head (single pole head) 100 must supply an increasing write current. In addition, if a small bit is recorded after recording a large bit, a large portion of the large bit remains unerased, thus deteriorating the overwrite properties.

As such, an advanced magnetic recording media is proposed that combines vertical recording in addition to the recording on the base of patterned media and comprises a magnetic metal filled within pores of anodizing alumina pores as shown in FIGS. 3A and 3B (e.g. JP-A No. 2002-175621). The magnetic recording medium comprises an underlayer electrode and anodized alumina pores on substrate 1 in this order as shown FIG. 4. Many alumina pores are arranged in a pattern at the anodized alumina pores, and a ferromagnetic metal is filled within the alumina pores to form ferromagnetic layer 14.

However, the anodized alumina pore layer of is usually required a thickness exceeding 500 nm so as to form regularly arrayed alumina pores therein, and information cannot be recorded therein at a high density even if the soft-magnetic underlayer is provided. To solve this problem, an attempt has been made to polish the anodized alumina pore layer to reduce its thickness. However, the polishing is difficult and time-consuming, thus inviting higher cost and poor quality of the product. In fact, in order to magnetically record information at a linear recording density of 1500 kBPI to realize a recording density of 1 Tb/in², the distance between the single pole head and the soft-magnetic underlayer must be reduced to approximately 25 nm, and the thickness of the anodized alumina pore layer must be reduced to approximately 20 nm. It takes much time and effort to polish the anodized alumina pore layer 130 to such a thickness.

In the magnetic recording medium comprising the anodized alumina pores filled with a magnetic material, the anodized alumina pores extend with a high aspect ratio in a direction perpendicular to an exposed surface. The medium is susceptible to magnetization in the perpendicular direction, is dimensionally anisotropic with respect to the magnetic material and is resistant to thermalfluctuation. The anodized alumina pores generally grow in a self-organizing manner to form honeycomb lattices of hexagonal closest packing and can be produced at lower cost than in the formation of such pores one by one by a lithographic technique.

As such, it is desired that the magnetic recording medium having a shorter distance between the single magnetic-pole head and the soft-magnetic underlayer and capable of recording with narrower magnetic field at the magnetic recording have a structure that a ferromagnetic and a soft-magnetic material is filled into the anodized alumina pores, as shown in FIG. 5.

The magnetic recording medium with such a structure may be produced by filling the soft-magnetic material and the ferromagnetic material into the alumina pores in order through a plating process for example. However, such a plating process suffers from fluctuation of filled amounts due to nonuniform plating rates of the metal plated within the alumina pores 16 as shown in FIG. 5, thus the thickness or height of the soft-magnetic layer 13 and the ferromagnetic layer 14 is likely to be variable, resulting in nonuniform magnetic properties.

As a matter of fact, the relation between the plating period and the thickness of the cobalt (Co) monolayer filled within alumina pores, where the respective alumite pores have approximately 20 nm diameter and approximately 1400 nm depth, represents a significant fluctuation of filled amounts even in the filling within a monolayer as shown in FIG. 6.

As described above, conventional methods can hardly provide metal laminates with a uniform amount in terms of thickness or height filled within alumite pores, thus the improvement has been demanded.

Further, laminate structures, having an insulating layer filled with a metal uniformly to a constant height within the pores, are applicable to nonvolatile memories, giant magneto resistance elements, spin valve films, tunnel effect films etc. in addition to magnetic recording media, therefore, the improvement has been demanded also.

The objects of the present invention are to solve the problems in the art described above and to provide a laminate structure with metal nanopillars, utilized widely in a wide range of fields such as magnetic recording media, nonvolatile memories, giant magneto resistance elements, spin valve films, tunnel effect films, various sensors, displays, and optical elements; a magnetic recording medium applicable to hard disk devices utilized commercially in various products such as external memory devices of computers and recording devices of public videos, wherein the magnetic recording medium can perform high-density recording and high-velocity recording with higher capacity without increasing write current at magnetic heads, and can exhibit excellent overwrite properties, uniform properties, lower noise, superior thermalfluctuation resistance, and higher quality; a method for producing the magnetic recording medium with higher efficiency and lower cost; a magnetic recording device, which comprises the magnetic recording medium in vertical recording, capable of recording with lower noise, superior thermalfluctuation resistance, and high-density recording; a method of magnetic recording; and an element, which comprises the laminate structure, properly utilized for nonvolatile memories, giant magneto resistance elements, spin valve films, tunnel effect films, various sensors, displays, and optical elements.

### SUMMARY OF THE INVENTION

The laminate structure according to the present invention comprises a number of metal nanopillars and plural insulating layers, wherein the lengths of the metal nanopillars are approximately equivalent, each of the plural insulating layers is penetrated by the metal nanopillars, and the plural insulating layers are laminated to each other.

When the metal nanopillars are formed of a magnetic material, the laminate structure may be applied to magnetic recording media such as hard disk devices; giant magneto resistance elements, spin valve films, and tunnel effect films; when the metal nanopillars are formed of a semiconductor material, the laminate structure may be applied to nonvolatile memories; when the metal nanopillars are formed of a sensor material, electrode material, optical material, etc., the laminate structure may be applied to various sensors, displays, optical elements, etc.

The magnetic recording medium according to the present invention comprises the laminate structure according to the present invention on the substrate, wherein the metal nanopillars are formed of a magnetic material and extend to a direction approximately perpendicular to the surface of the substrate.

The magnetic recording medium may perform high-density recording and high-velocity recording with higher capacity without increasing write current at the magnetic head, and may exhibit excellent overwrite properties, uniform properties, lower noise, superior thermalfluctuation resistance, and higher quality, since the metal nanopillars of the magnetic material are arranged into each of the laminated insulating layers. The magnetic recording medium may be appropriately applied to hard disk devices utilized commercially in various products such as external memory devices of computers and recording devices of public videos.

The method for producing a laminate structure according to the present invention may produce the laminate structure according to the present invention, and comprises forming a number of first nanoholes within a first insulating layer while forming the first insulating layer, filling a material of metal nanopillars into the first nanoholes to form first metal nanopillars, treating the surface of the first insulating layer within which the first metal nanopillars are formed, forming a number of second nanoholes within a second insulating layer while forming the second insulating layer on the first insulating layer, filling a material of metal nanopillars into the second nanoholes to form second metal nanopillars, thereby forming a laminate structure comprising a number of metal nanopillars and plural insulating layers.

In the method for producing a laminate structure, the step of forming the first nanoholes produces a number of nanoholes within the first insulating layer while forming the first insulating layer;

consequently, a number of nanoholes are formed within the first insulating layer. The step of forming the first metal nanopillars produces metal nanopillars within the nanoholes; consequently, the first insulating layer is formed within which a number of metal nanopillars are formed. The step of treating the surface treats the surface of the first insulating layer within which the metal nanopillars are formed, consequently, the surface of the insulating layer is smoothened, and a number of metal nanopillars within the first insulating layer are trimmed or equalized with respect to the height or length. The step of forming the second nanoholes produces a number of nanoholes within the second insulating layer while forming the second insulating layer on the first insulating layer after surface treatment thereof; consequently, the second insulating layer having a number of nanoholes are laminated on the first insulating layer. The step of forming the second metal nanopillars forms metal nanopillars within the second nanoholes; consequently, the second insulating layer having a number of metal nanopillars is laminated on the first insulating layer; as a result, the laminate structure according to the present invention may be produced.

When the metal nanopillars having an approximately equivalent length are formed of a magnetic material, the laminate structure may be applied to magnetic recording media such as hard disk devices; giant magneto resistance elements, spin valve films, and tunnel effect films; when the metal nanopillars are formed of a semiconductor material, the laminate structure may be applied to nonvolatile memories; when the metal nanopillars are formed of a sensor material, electrode material, optical material, etc., the laminate structure may be applied to various sensors, displays, optical elements, etc.

The method for producing a magnetic recording medium according to the present invention may produce the magnetic recording medium according to the present invention, and comprises forming a number of first nanoholes within a first insulating layer of a nonmagnetic material while forming the first insulating layer on a substrate, filling a magnetic material into the first nanoholes to form first metal nanopillars, treating the surface of the first insulating layer within which the first metal nanopillars are formed, forming a number of second nanoholes into a second insulating layer while forming the second insulating layer by use of a nonmagnetic material on the first insulating layer, and filling a material of metal nanopillars into the second nanoholes to form second metal nanopillars.

In the method for producing a magnetic recording medium, the step of forming the first nanoholes produces a number of nanoholes within the first insulating layer on the substrate while forming the first insulating layer by use of a nonmagnetic material; consequently, a number of nanoholes are formed within the first insulating layer on the substrate. The step of forming the first metal nanopillars produces. metal nanopillars by filling the magnetic material into the nanoholes; consequently, the first insulating layer is formed within which a number of metal nanopillars are formed. The step of treating the surface treats the surface of the first insulating layer within which the metal nanopillars are formed, consequently, the surface of the second insulating layer is smoothened, and a number of metal nanopillars within the first insulating layer are trimmed or equalized with respect to the height or length. The step of forming the second nanoholes produces a number of nanoholes within the second insulating layer while forming the second insulating layer by use of the nonmagnetic material on the first insulating layer after the surface treatment; consequently, the second insulating layer having a number of nanoholes are laminated on the first insulating layer. The step of forming the second metal nanopillars forms metal nanopillars by filling the magnetic material into the nanoholes; consequently, the second insulating layer having a number of metal nanopillars is laminated on the first insulating layer; as a result, the magnetic recording medium according to the present invention may be produced.

When the metal nanopillars within the first insulating layer on the substrate is formed of a soft-magnetic material and the metal nanopillars within the second insulating layer on the substrate is formed of a ferromagnetic material, a magnetic recording medium may be obtained that comprises sequentially the substrate, the soft-magnetic material, and the ferromagnetic material, wherein the soft-magnetic material as well as the ferromagnetic material fill into alumite pores in a condition of substantially uniform thickness or height.

The magnetic recording device according to the present invention comprises the magnetic recording medium according to the present invention.

Since a number of metal nanopillars of the magnetic material extend to a direction approximately perpendicular to the surface of the substrate, the magnetic recording medium may be utilized as a patterned medium of single-domain structure rather than complex-domain structure. When recorded by means of a head for vertical magnetic recording, the magnetic recording medium may perform high-density recording and high-velocity recording with higher capacity without increasing write current at the magnetic head, and may exhibit excellent overwrite properties, uniform properties, lower noise, superior thermalfluctuation resistance, and higher quality.

When magnetic recording is performed to the magnetic recording medium by use of a head for vertical magnetic recording such as a single magnetic-pole head, only the thickness of the ferromagnetic layer may control the concentration of magnetic flux from the head for vertical magnetic recording, optimum properties of magnetic recording and regeneration at the employed recording density, and the like, regardless of the total thickness of the first insulating layer and the second insulating layer, since the distance between the head for vertical magnetic recording and soft-magnetic underlayer is shorter than the total thickness of the first insulating layer and the second insulating layer, and approximately the same as the thickness of the ferromagnetic layer. In this case, as shown in FIG. 7, the magnetic flux from the single magnetic-pole head or read-write head 100 concentrates to the ferromagnetic layer or vertical magnetizing film 14, consequently, write efficiency is improved remarkably, writing current is reduced, overwrite properties are improved, noise is lowered, and thermalfluctuation resistance is superior, compared to the conventional magnetic recording devices.

The magnetic recording method according to the present invention may record the magnetic recording medium according to the present invention by use of a head for vertical magnetic recording.

Since the magnetic recording method records the magnetic recording medium by use of the head for vertical magnetic recording, high-density recording and high-velocity recording may be attained without increasing write current at the magnetic head. The magnetic recording medium may exhibit higher capacity, excellent overwrite properties, uniform properties, lower noise, superior thermalfluctuation resistance, and higher quality.

When magnetic recording is performed to the magnetic recording medium by use of a head for vertical magnetic recording such as a single magnetic-pole head, only the thickness of the ferromagnetic layer may control the concentration of magnetic flux from the head for vertical magnetic recording, optimum properties of magnetic recording and regeneration at the employed recording density, and the like, regardless of the total thickness of the first insulating layer and the second insulating layer, since the distance between the head for vertical magnetic recording and soft-magnetic underlayer is shorter than the total thickness of the first insulating layer and the second insulating layer, and approximately the same as the thickness of the ferromagnetic layer. In this case, as shown in FIG. 7, the magnetic flux from the single magnetic-pole head or read-write head 100 concentrates to the ferromagnetic layer or vertical magnetizing film 14, consequently, write efficiency is improved remarkably, writing current is reduced, overwrite properties are improved, noise is lowered, thermalfluctuation resistance is superior, compared to the conventional magnetic recording devices.

The element according to the present invention comprises the laminate structure according to the present invention.

When the metal nanopillars of the laminate structure are formed of a magnetic material, the laminate structure may be applied to magnetic recording media such as hard disk devices; giant magneto resistance elements, spin valve films, and tunnel effect films; when the metal nanopillars are formed of a semiconductor material, the element may be applied to nonvolatile memories; when the metal nanopillars are formed of a sensor material, electrode material, optical material, etc., the element may be applied to various sensors, displays, optical elements, etc.

### BRIEF DESCRIPTION OF THE DRAWING

FIG. 1 is an exemplary conception view that schematically shows a magnetic recording in a vertical recording system.

FIG. 2A is an exemplary conception view that schematically explains diffusion of magnetic flux during magnetic recording in a vertical recording system.

FIG. 2B is an exemplary conception view that schematically explains concentration rather than diffusion of magnetic flux during magnetic recording in a vertical recording system.

FIGS. 3A and 3B are an exemplary view that explains a magnetic recording medium where a magnetic metal is filled into anodized alumina pores arranged two-dimensionally.

FIG. 4 is an exemplary view of a magnetic recording medium that combines a patterned media and a vertical recording system where a magnetic metal is filled into anodized alumina pores.

FIG. 5 is an exemplary view of a conventional magnetic recording medium that combines a patterned media and a vertical recording system where a magnetic metal is filled into anodized alumina pores and the thickness of the magnetic layer is nonuniform.

FIG. 6 shows Co condition filled into anodized alumina pores by a plating process and a relation between plating period and Co thickness.

FIG. 7 exemplarily shows a partially cross-sectional view that explains a magnetic recording onto a magnetic recording medium by means of a vertical recording system and a single magnetic-pole head.

FIG. 8 is an exemplary view that shows the first step for producing the laminate structure of the present invention.

FIG. 9 is an exemplary view that shows the second step for producing the laminate structure of the present invention.

FIG. 10 is an exemplary view that shows the third step for producing the laminate structure of the present invention.

FIG. 11 is an exemplary view that shows the fourth step for producing the laminate structure of the present invention.

FIG. 12 is an exemplary view that shows the fifth step for producing the laminate structure of the present invention.

FIG. 13 is an exemplary view that shows the sixth step for producing the laminate structure of the present invention.

FIG. 14 is an exemplary view that shows the seventh step for producing the laminate structure of the present invention.

FIG. 15 is an exemplary view that shows the first step for producing the magnetic recording medium of the present invention.

FIG. 16 is an exemplary view that shows the second step for producing the magnetic recording medium of the present invention.

FIG. 17 is an exemplary view that shows the third step for producing the magnetic recording medium of the present invention.

FIG. 18 is an exemplary view that shows the fourth step for producing the magnetic recording medium of the present invention.

FIG. 19 is an exemplary view that shows the fifth step for producing the magnetic recording medium of the present invention.

FIG. 20 is an exemplary view that shows the sixth step for producing the magnetic recording medium of the present invention.

FIG. 21 is an exemplary view that shows the seventh step for producing the magnetic recording medium of the present invention.

FIG. 22 is an exemplary view that shows the eighth step for producing the magnetic recording medium of the present invention.

FIG. 23 is an exemplary view that shows a surface condition of an insulating layer where nanoholes are formed.

FIG. 24A is an exemplary view that explains a surface condition of an aluminum layer after a mold is imprint-transferred.

FIG. 24B is an exemplary view that shows nanohole arrays obtained by anodizing the aluminum layer shown in FIG. 24A.

FIG. 25 is an exemplary view that shows nanohole arrays obtained by anodization.

FIGS. 26A to 26F are schematic diagrams that explain a example of a method for manufacturing the magnetic recording medium as an embodiment of the present invention. FIG. 26A shows mold preparation process. FIGS. 26B and 26C show imprint process. FIG. 26D shows anodization process. FIG. 26E shows magnetic meal electrodeposition process. FIG. 26F shows polishing process.

FIG. 27A is a schematic view that explains a condition before nanohole arrays being formed into a magnetic recording medium of the present invention in a configuration that the width alters with a certain distance.

FIG. 27B is a schematic view that explains a condition after nanohole arrays being formed into a magnetic recording medium of the present invention in a configuration that the width alters with a certain distance.

FIG. 28A is a schematic view that explains a condition before nanohole arrays being formed into a magnetic recording medium of the present invention in a configuration that the arrays are sectioned with a certain distance.

FIG. 28B is a schematic view that explains a condition after nanohole arrays being formed into a magnetic recording medium of the present invention in a configuration that the arrays are sectioned with a certain distance.

FIG. 29 is a schematic view that exemplarily shows a phase-change memory of the present invention.

FIG. 30 is an exemplary view that shows the first step for producing a phase-change memory of the present invention.

FIG. 31 is an exemplary view that shows the second step for producing a phase-change memory of the present invention.

FIG. 32 is an exemplary view that shows the third step for producing a phase-change memory of the present invention.

FIG. 33 is an exemplary view that shows the fourth step for producing a phase-change memory of the present invention.

FIG. 34 is an exemplary view that shows the fifth step for producing a phase-change memory of the present invention.

FIG. 35 is a schematic view that exemplarily explains a giant magneto resistance (GMR) element of the present invention.

FIG. 36 is a schematic view that exemplarily explains a giant magneto resistance (GMR) element of the present invention.

FIG. 37 is a graph that shows signal amplitudes measured under a lead condition and off-track.

FIG. 38 is a schematic enlarged view of a connecting portion between a heating element and a memory element of a phase-change memory.

FIG. 39 is a graph that shows a relation between annealing temperature and relative resistivity of a memory element in a phase-change memory.

FIG. 40 is a graph that shows an exemplary relation between film thickness and resistivity in a giant magneto resistance (GMR) element of multilayer type.

FIG. 41 is a graph that shows still another exemplary relation between film thickness and resistivity in a giant magneto resistance (GMR) element of multilayer type.

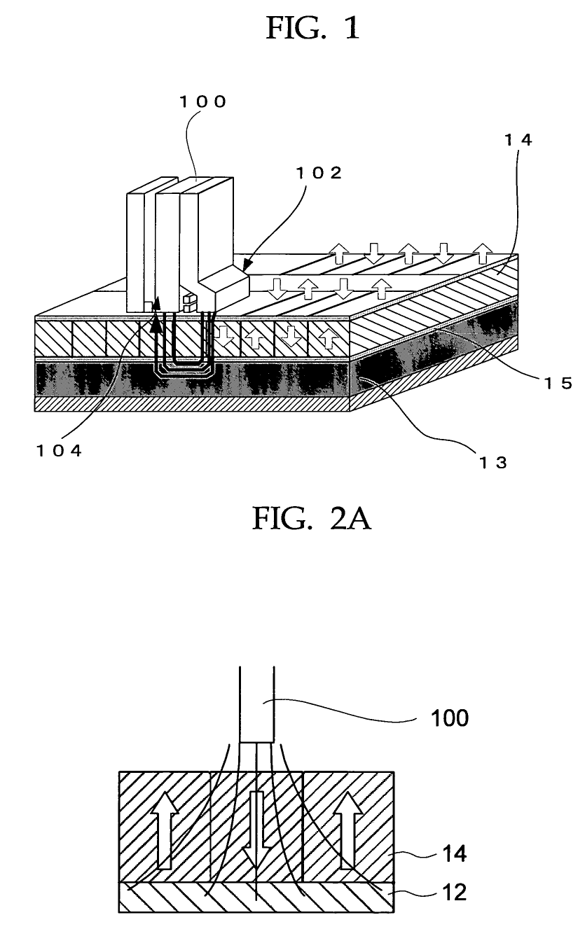

### DESCRIPTION OF THE PREFERRED EMBODIMENTS

(Laminate Structure and Method for Producing the Same)

The laminate structure of the present invention comprises plural insulating layers in a laminated condition and may comprise the other optional layers such as an intermediate layer depending on requirements, wherein each insulating layer is penetrated by metal nanopillars. In the configuration that “n” layers are laminated to form the insulating layers of the laminate structure of the present invention, the insulating layers are sometimes referred to as the first layer, the second layer, the third layer, - - - the “n”th layer.

The laminate structure of the present invention may be properly produced by the method for producing the laminate structure of the present invention. The method for producing the laminate structure of the present invention comprises a step for forming nanoholes, a step for forming metal nanopillars, a surface-treatment step, a second step for forming nanoholes, a second step for forming metal nanopillars, and the other steps selected depending on requirements. For producing the laminate structure of three layers, the surface-treatment step is performed after the second step for forming metal nanopillars, and further a third step for forming nanoholes and a third step for forming metal nanopillars performed; for producing the laminate structure of four or more layers, the surface-treatment step is performed after the third step for forming metal nanopillars, and further a fourth step for forming nanoholes, a fourth step for forming metal nanopillars performed, and the surface-treatment step is performed repeatedly.

The laminate structure of the present invention and the method for producing the same will be explained in the following.

— Insulating Layer —

The material, shape, structure, size, etc. of the insulating layer may be properly selected depending on the application.

The material of the insulating layer may be properly selected without particular limitations, for example, from elementary metals, as well as oxides, nitrides, and alloys thereof. Among these, alumina or aluminum oxide, glasses, and silicon are preferable, and alumina is preferable in particular. The material of the insulating layer may be the insulating material that is transformed from a metal material by way of nanohole formation through an anodization process etc. The metal material is preferably aluminum.

Preferably, the material of the insulating layer exhibits an etching rate different from that of the material of nanopillars under an identical etching conditions of ion milling, chemical-mechanical polishing etc., more preferably, the material of the insulating layer exhibits an etching rate higher than that of the material of nanopillars, which may provide an advantage that respective insulating layers are easily obtained that contain a number of metal nanopillars with substantially the same thickness or length in the laminate structure.

The shape of the insulating layer may be properly selected depending on the application, for example, may be plate, circular, disk, and the like. Among these, the shape is preferably circular plate or disk when the laminate structure is applied to magnetic recording media such as hard disks.

— Metal Nanopillar —

The material, shape, structure, size, etc. of the metal nanopillars may be properly selected depending on the application.

The material of the metal nanopillars may be properly selected without particular limitations, for example, from magnetic materials, nonmagnetic materials, and phase-change materials. The magnetic materials involve ferromagnetic materials and soft-magnetic materials. Examples of the ferromagnetic materials preferably include Fe, Co, Ni, FeCo, FeNi, CoNi, CoNiP, FePt, CoPt, and NiPt. These may be used alone or in combination. Examples of the soft-magnetic materials preferably include NiFe, FeSiAl, FeC, FeCoB, FeCoNiB, and CoZrNb. These may be used alone or in combination.

The nonmagnetic material may be properly selected without particular limitations from conventional ones adapted to nonmagnetic layers in magnetic recording media; example thereof include Cu, Al, Cr, Pt, W, Nb, Ru, Ta, and Ti. These may be used alone or in combination.

The phase-change material may be properly selected without particular limitations from conventional ones adapted to nonvolatile memory materials; examples thereof include materials of chalcogenide film such as GeSbTe.

The shape of nanopillars is like a pillar or rod. The diameter of nanopillars in the cross section may be properly selected depending on the application. When the laminate structure is applied to magnetic recording media such as hard disks and the metal nanopillars are utilized as a ferromagnetic layer, the ferromagnetic layer is preferably of a single-domain size; specifically, the diameter of nanopillars is preferably 200 nm or less, more preferable is 100 nm or less, and particularly preferable is 5 nm to 100 nm.

When the diameter of nanopillars in the cross section exceeds 200 nm, the magnetic recording medium that comprises the laminate structure may not represent a single-domain structure. The diameters of nanopillars in the cross section may be substantially the same or different in terms of the entire nanopillars.

The length of metal nanopillars may be properly selected depending on the application; preferably, the length is 1 nm to 10,000 nm, more preferable is 1 to 200 nm, and particularly preferable is 1 nm to 100 nm from the viewpoint of signal strength from record heads of magnetic recording media.

The aspect ratio of length to diameter in the cross section of metal nanopillars, i.e. length÷diameter in cross section, may be properly selected depending on the application. The higher aspect ratio is preferred from the viewpoint that the retention ability of the magnetic recording media is increased when applied to magnetic recording media due to the enlarged shape anisotropy. For example, when the laminate structure is applied to magnetic recording media such as hard disks, the aspect ratio is preferably 2 or more, more preferably 3 to 15.

When the aspect ratio is less than 2, the retention ability of the magnetic recording media may be insufficient when the laminate structure is applied to magnetic recording media.

The space or space between adjacent metal nanopillars may be properly selected depending on the application. When the laminate structure is applied to magnetic recording media such as hard disks, the space is preferably 5 nM to 500 nm, and more preferably 10 nm to 200 nm.

When the space is less than 5 nm, the metal nanopillars may be hardly produced, and when more than 500 nm, the magnetic recording medium that comprises the laminate structure may not represent a single-domain structure. The spaces may be substantially the same in terms of the entire metal nanopillars, or the spaces may be different respectively.

The ratio of the space between adjacent nanopillars to the diameter of nanopillars (i.e. space÷diameter) may be properly selected depending on the application; preferably the ratio is 1.1 to 1.9, more preferably 1.2 to 1.8.

The ratio (space÷diameter) less than 0.1 may invite fusion of adjacent metal nanopillars and fail to provide separation of metal nanopillars, and the ratio of more than 1.9 may invite formation of extra nanoholes at sites other than predetermined sites in anodization process.

The arrangement of metal nanopillars may be properly selected depending on the application; preferably, the arrays of metal nanopillars are arranged in a concentric or spiral pattern. Such a pattern may make the magnetic recording media suitable for hard disks when the laminate structure is applied to magnetic recording media.

Preferably, metal nanopillars are formed in a direction that the surfaces of the insulating layer are penetrated, metal nanopillars extend perpendicularly to the surfaces of the insulating layer, and the insulating layer is penetrated by the metal nanopillars.

In the insulating layer where metal nanopillars are formed, the metal nanopillars may project from the insulating layer at the surface of the insulating layer, alternatively the insulating layer may project from the metal nanopillars.

The number of the laminated insulating layers may be properly selected depending on the application as long as the number is 2 or more; preferably, the number is 2 to 30, more preferably 2 to 15.

In the laminated insulating layers, metal nanopillars are formed at approximately the same sites in the adjacent insulating layers, and the metal nanopillars in the adjacent insulating layers may be contacted or non-contacted each other. The contacted nanopillars may make the laminate structure more suitable for the magnetic recording media.

In the laminated insulating layers, the materials of metal nanopillars may be identical between the adjacent insulating layers, and the insulating materials may be identical between the adjacent insulating layers.

When the materials of metal nanopillars are identical, the materials of metal nanopillars are identical in between the respective adjacent insulating layers, and also when the sites and diameters of metal nanopillars are identical between the respective adjacent insulating layers, the condition is similar to that each of the metal nanopillar penetrates throughout plural insulating layers. When the materials of the insulating layers are identical also, the materials of the insulating layers are identical throughout the respective insulating layers, and also when the sites and diameters of metal nanopillars are identical between the respective insulating layers, the condition is similar to that one or more species of metal nanopillars are formed within one insulating layer. Further, when the materials of the nanopillars and the materials of the insulating layers are identical also, the materials of the nanopillars and the insulating layers are identical throughout the respective insulating layers, and also when the sites and diameters of metal nanopillars are identical in the respective insulating layers, the condition is similar to that one species of metal nanopillars are formed within one insulating layer.

With respect to these cases, the lamination of the insulating layer may be recognized through observation by means of electron microscope such as SEM and/or TEM images.

In the laminated insulating layers, the material, diameter, and length of metal nanopillars may be substantially the same or different between the adjacent insulating layers. In the laminated insulating layers, the material and thickness of the adjacent insulating layers may be substantially the same or different.

In the laminated insulating layers, an intermediate layer may be formed between the adjacent insulating layers. The intermediate layer may be properly selected depending on the application; preferably the intermediate layer is formed of a material insoluble or hardly soluble under an anodization process, more preferably is formed of Nb. In such configuration, the anodization of the insulating layer may be stopped at the intermediate layer and the excessive anodization may be advantageously prevented when the insulating layer is subjected to anodization after the insulating layer is laminated on an insulating layer where the metal nanopillars are formed.

The thickness of the intermediate layer may be properly selected depending on the application; preferably the thickness is 20 nm or less.

The intermediate layer may be easily removed by a conventional etching process using a conventional etching liquid such as phosphoric acid.

The thickness of the laminate structure may be properly selected depending on the application. When the laminate structure is applied to magnetic recording media such as hard disks, the thickness is preferably 500 nm or less, more preferably is 300 nm or less, and still more preferably is 20 to 200 nm.

When the laminate structure having a thickness of more than 500 nm is applied to magnetic recording media such as hard disks, information may not be recorded thereon at a high density even if the magnetic recording medium further comprises a soft-magnetic underlayer, therefore the laminate structure is to be polished to reduce the thickness, thus the production of the magnetic recording medium may be time-consuming and higher cost, and may lead to poor quality.

The laminate structure of the present invention may be appropriately applied widely such as to magnetic recording media, nonvolatile memories, giant magneto resistance elements, spin valve films, tunnel effect films, various sensors, displays, and optical elements, in particular to hard disk devices utilized in various products such as external memory devices of computers and recording devices of public videos.

The laminate structure of the present invention may be produced by a method properly selected depending on the application, preferably is produced by the method for producing a laminate structure of the present invention as described above.

The method for producing a laminate structure of the present invention comprises a step for forming nanoholes, a step for forming metal nanopillars, a surface-treatment step, a second step for forming nanoholes, a second step for forming metal nanopillars, and the other steps selected depending on requirements.

— Formation of Nanoholes —

In the step for forming nanoholes, an insulating layer is formed and a number of nanoholes are formed within the insulating layer.

The method for forming the insulating layer may be properly selected from conventional methods depending on the application; a preferable method is that a metal layer is formed from a metal material by way of a sputtering method, vapor deposition method, etc., then the metal layer is subjected to a nanohole-forming step such as anodization. The material of the metal layer may be aluminum.

The conditions to form the metal layer may be properly selected depending on the application. When the sputtering method is employed, the sputtering can be carried out by using a target made of the material of the metal layer. The target employed in the method is preferably of high purity, and preferably has a purity of 99.99% or more when the material of the metal layer is aluminum.

The method for forming nanoholes may be properly selected depending on the application; examples thereof include anodization and etching. Among these, anodization is preferred in particular from the viewpoint that many uniform nanoholes with substantially an equal space or interval therebetween can be formed in a direction extending substantially perpendicular to the surface of insulating layer while the metal layer being transformed into the insulating layer.

The voltage in the anodization process may be properly selected depending on the application; preferably, the voltage is controlled into the following range: V=D/A, wherein V is the voltage in the anodization; D is the diameter (nm) of nanoholes; and A is a value (nm/V) of 1.0 to 4.0.

When the anodization is carried out at the voltage within the range, the arrangement of nanoholes may be advantageously controlled with easiness.

The species, concentration, and temperature of the electrolyte and the time period for the anodization may be properly selected depending on the number, size, and aspect ratio of the intended nanoholes. For example, the electrolyte is preferably a diluted phosphoric acid solution when the space or pitch of adjacent rows of nanoholes is 150 nm to 500 nm; the electrolyte is preferably a diluted oxalic acid solution when the space or pitch is 80 nm to 200 nm; and the electrolyte is preferably a diluted sulfuric acid solution when the space or pitch is 10 nm to 150 nm. In any case, the aspect ratio of the nanoholes can be controlled by immersing the anodized metal layer in, for example, a phosphoric acid solution to thereby increase the diameter of the nanoholes such as alumina pores.

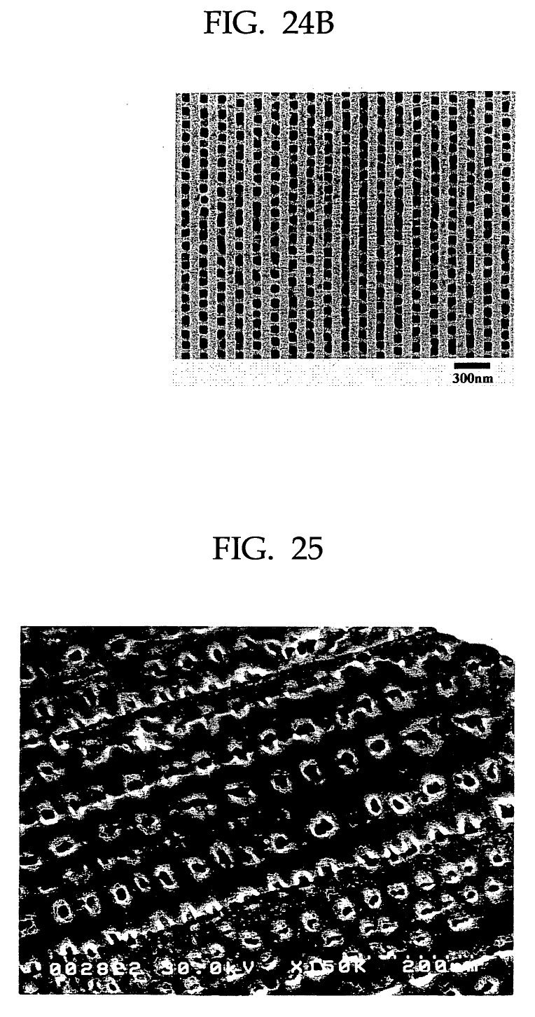

Preferably, lines of concave portions are previously prepared on the insulating layer for the arrangement of nanoholes prior to the anodization (see FIG. 24A). Such lines provide an effective benefit that nanoholes may be formed exclusively on the lines of concave portions by the anodization (see FIGS. 24B and 25). The lines of concave portions may have any suitable sectional profile in a direction perpendicular to the longitudinal direction such as a rectangular, V-shaped, or semicircular profile.

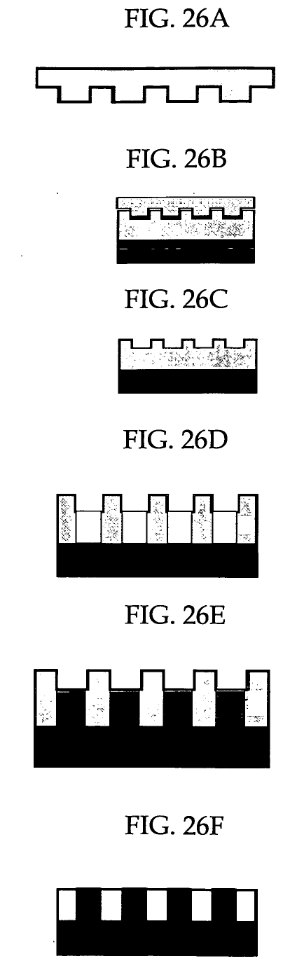

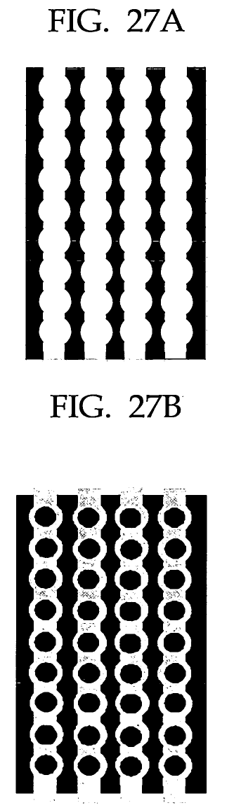

The lines of concave portions can be formed by any suitable method depending on the application. Examples of such methods are (1) a method in which a mold having a line-and-space pattern comprising lines of convex portions on its surface is imprinted and the pattern is transferred to the metallic layer made of, for example, aluminum to thereby form a line-and-space pattern comprising rows of concave portions and spaces arranged at specific spaces alternately as shown in FIGS. 26A to 26F, wherein the convex portions are preferably arranged concentrically or spirally when the nanohole structure is used in the magnetic recording disk (see FIG. 24A); (2) a method in which a resin layer or photoresist layer is formed on the metallic layer, then is patterned and etched to thereby form lines of concave portions on a surface of the metallic layer; and (3) a method in which grooves or lines of concave portions are directly formed on a surface of the metallic layer.

The width of the lines of nanoholes may be varied widely or narrowly at specific spaces or periods in a longitudinal direction of the lines by periodically varying, for example, the width of the lines of convex portions in the mold or the width of the pattern of lines of concave portions formed in the photoresist layer at specific intervals in its longitudinal direction (see FIG. 27A). When the laminate structure, formed by laminating the insulating layers that contain metal nanopillars filled within nanoholes (see FIG. 27B), is applied to the magnetic recording medium, high-density recording is advantageously possible with reduced jitter.

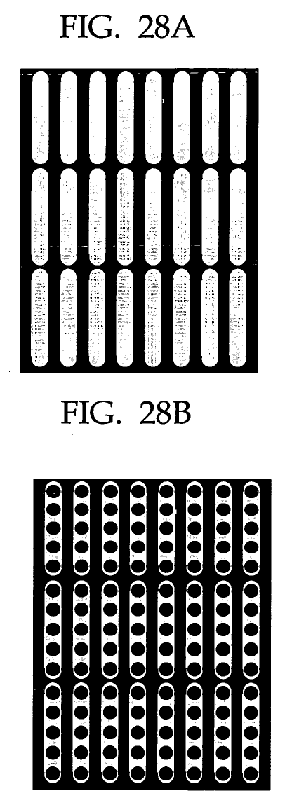

The mold may be properly selected depending on the application; one preferable example is silicon carbide substrate from the viewpoint of durability under continuous usage, another example is a Ni stamper used in molding of optical disks. The mold may be of the shape shown in FIG. 28A, which yields metal nanopillars of the pattern shown in FIG. 28B. The mold may be utilized plural times.

The imprint-transfer method may be properly selected from conventional ones depending on the application. The resist material for the photoresist layer includes not only photoresist materials but also electron beam resist materials. The photoresist material utilized in the present invention may be properly selected from conventional ones in the field of semiconductors depending on the application, specifically, materials sensitive to near-ultraviolet rays or near-field light are exemplified.

The nanoholes or pores are formed in a direction approximately perpendicular to an exposed surface or layer surface of the insulating layer. The nanoholes may be holes that penetrate through the insulating layer or pores or depressions that do not penetrate through the insulating layer. When the laminate structure is applied to magnetic recording media, the nanoholes are preferably through holes that penetrate the nanohole structure.

The size of the nanoholes may be properly selected depending on the size of metal nanopillars to be formed. For example, when the laminate structure is applied to magnetic recording media such as hard disks, the size is preferable correspondent to the size of the conventional hard disks; when the laminate structure is applied to DNA chips, the size is preferable correspondent to the size of the DNA chips; and when the laminate structure is applied to catalysis substrates of carbon nanotubes for field emission devices, the size is preferable correspondent to the size of the field emission devices.

The arrangement or alignment of the nanoholes may be properly selected depending on the application; for example, the nanoholes may be aligned in one direction in parallel, or arranged concentrically or spirally. When the laminate structure is applied to DNA chips, the former is preferable, and when the laminate structure is applied magnetic recording media such as hard disks and video disks, the latter is preferable. Specifically, concentric arrangement is preferable for hard disks from the viewpoint of easy access, and spiral arrangement is preferable for video disks from the viewpoint easy continuous regeneration.

When the laminate structure is applied to magnetic recording media such as hard disks, nanoholes within adjacent nanohole arrays are preferably arranged in the radius direction. In such arrangement, the magnetic recording medium can perform high-density recording and high-velocity recording with higher capacity without increasing write current at magnetic heads, and can exhibit excellent overwrite properties, uniform properties, lower noise, superior thermalfluctuation resistance, and higher quality.

— Step for Forming Metal Nanopillars —

In the step for forming metal nanopillars, the material of metal nanopillars is filled within the nanoholes to form the metal nanopillars.

The method for forming the metal nanopillars may be properly selected depending on the application; a preferable example thereof is that the material of metal nanopillars is filled or deposited into the nanoholes.

The method for filling the material of metal nanopillars may be properly selected depending on the application; preferable examples include plating methods and electrodeposition methods from the viewpoint that the material of metal nanopillars may be filled into deeply inside of nanoholes.

Specific examples of the plating method include electroless plating and electrolytic plating. The conditions of the plating method may be properly selected depending on the application.

The methods and conditions of the electrodeposition method may be properly selected depending on the application; a preferable example is that a voltage is applied to an electrode of a soft-magnetic underlayer or electrode layer using one or more species of solutions containing the materials of the soft-magnetic layer, thereby to precipitate or deposit the material on the electrode.

— Step for Surface Treatment —

In the step for surface treatment, the insulating layer, into which the metal nanopillars have been formed, is subjected to surface treatment.

The surface treatment may be properly selected depending on the application; preferably, the surface of the insulating layer may be polished by the treatment. Preferable examples of the surface treatment include chemical-mechanical polishing processes, ion milling processes, and the like. The specific conditions of the surface treatment may be properly selected depending on the application.

In the step for surface treatment, the material of the insulating layer, e.g. alumina, and the material of the metal nanopillars, e.g. Co, exhibit different etching rates under an identical condition of etching treatment. For example, under an ion milling treatment using Ar gas of ion accelerating voltage 300 V and current 300 mA, the milling rate of Co is 0.4 nm/sec and the milling rate of alumina is 0.1 nm/sec. Since the material of metal nanopillars, e.g. Co, exhibits higher etching rate than that of the material of the insulating layer, e.g. alumina, the metal nanopillars are more depressed than the insulating layer, namely the exposed ends of the metal nanopillars in the insulating layer represent a concave condition and exist more closely to the substrate than the adjacent insulating parts. The step for surface treatment may make substantially constant the length or height of the metal nanopillars within the insulating layer. Consequently, magnetic recording media that involve the resultant laminate structure may exhibit lower noise and superior thermalfluctuation resistance.

In the present invention, a step for forming an intermediate layer may be provided following the step for surface treatment and prior to the second step for forming nanoholes.

— Step for Forming Intermediate Layer —

In the step for forming the intermediate layer, an intermediate layer is formed on the surface of the insulating layer to which the surface treatment has been performed. The method for forming the intermediate layer may be properly selected from conventional ones; examples thereof include sputtering methods and vapor deposition methods. The materials for the intermediate layer are described above.

— Second Step for Forming Nanoholes —

In the second step for forming nanoholes, a number of nanoholes are formed within a second insulating layer while forming the second insulating layer on the first insulating layer to which the surface treatment has been performed. The second step for forming nanoholes may be carried out after the step for forming metal nanopillars or after the step for forming the intermediate layer. The second step for forming nanoholes may be carried out in substantially the same way as the step for forming nanoholes described above.

— Second Step for Forming Metal Nanopillars —

In the second step for forming metal nanopillars, the material of the metal nanopillars is filled within the nanoholes of the second insulating layer, thereby to form metal nanopillars. The second step for forming metal nanopillars may be carried out in substantially the same way as the step for forming metal nanopillars described above.

The second step for forming metal nanopillars may bring about the laminate structure of the present invention, in which the second insulating layer that involves the metal nanopillars is laminated on the first insulating layer that involves metal nanopillars.

The repeated process of the step for surface treatment, the step for forming nanoholes, and the step for forming metal nanopillars after the step for forming the second metal nanopillars may increase the laminate number of the laminate structure.

The laminate structure of the present invention and the method for producing thereof will be explained with reference to figures as follows.

Initially, a first metal layer is formed on the substrate 1 as lo shown in FIG. 8. The first metal layer is subjected to the treatment for forming nanoholes, a number of nanoholes are formed in the direction perpendicular to the surface of substrate 1 while the metal layer being transformed into the first insulating layer 2. These procedures correspond to the step for forming metal nanoholes.

Then, the nanoholes are filled or deposited with the material of the metal nanopillars, thereby metal nanopillars 20 are formed that are made of the material of the metal nanopillars described above. These procedures correspond to the step for forming metal nanopillars.

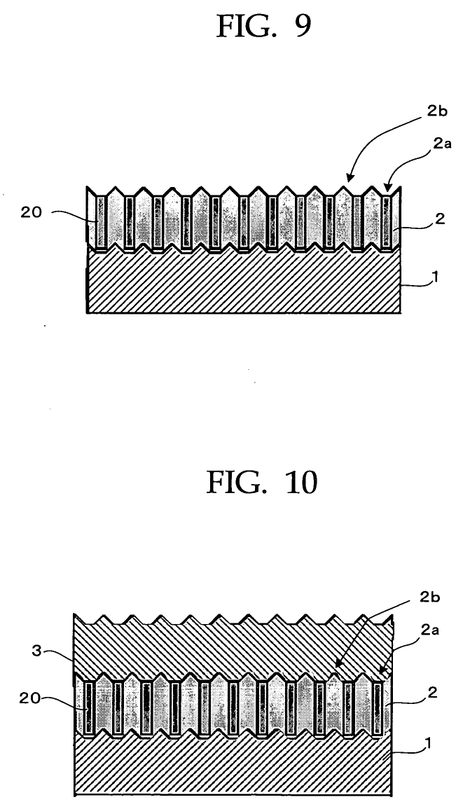

Then, the exposed surface of the insulating layer 2, into which metal nanopillars 20 have been formed, is subjected to the step for surface treatment as shown in FIG. 9. The material of the first insulating layer 2 and the material of the metal nanopillars 20 typically exhibit different etching rates under identical conditions of etching treatment, therefore, when the etching rate of the material of the metal nanopillars 20 is higher than that of the material of the first insulating layer 2, the metal nanopillars 20 are more depressed than the first insulating layer 2, namely the exposed ends 2a of the metal nanopillars in the first insulating layer 2 represent a concave condition and exist more closely to the substrate 1 than the adjacent insulating parts 2b as shown in FIG. 9. These procedures correspond to the step for surface treatment. The step for surface treatment may make substantially constant the length or height of the metal nanopillars 20 within the insulating layer 2.

Next, the second metal layer is formed on the first insulating layer 2, to which the step for surface treatment has been performed, as shown in FIG. 10. The second metal layer exhibits a concavoconvex surface owing to the concavoconvex surface of the first insulating layer 2. Then, the surface of the second metal layer is provided with a pattern so as to form nanoholes, followed by subjecting the second metal layer to the step for forming nanoholes such as anodization, thereby many nanoholes 10 are formed in a direction perpendicular to the surface of the substrate 1 while the metal layer being transformed into the second insulating layer 3. The nanoholes 10 are formed at the concave portions of the surface of the second insulating layer 3. These procedures correspond to the second step for forming nanoholes.

Then, the material of the nanopillars are filled or deposited into the nanoholes 10 as shown in FIG. 12, thereby metal nanopillars 30 are produced that is formed of the material of the metal nanopillars described above. These procedures correspond to the second step for forming metal nanopillars.

Then, the exposed surface of the insulating layer 3, into which metal nanopillars 30 have been formed, is subjected to the step for surface treatment. The material of the second insulating layer 3 and the material of the metal nanopillars 30 typically exhibit different etching rates under identical conditions of etching treatment, therefore, when the etching rate of the material of the metal nanopillars 30 is higher than that of the material of the second insulating layer 3, the metal nanopillars 30 are more depressed than the second insulating layer 3, namely the exposed ends 3a of the metal nanopillars in the second insulating layer 3 represent a concave condition and exist more closely to the substrate 1 than the adjacent insulating parts 3b. These procedures correspond to the step for surface treatment. The step for surface treatment may make substantially constant the length or height of the metal nanopillars 30 within the insulating layer 3.

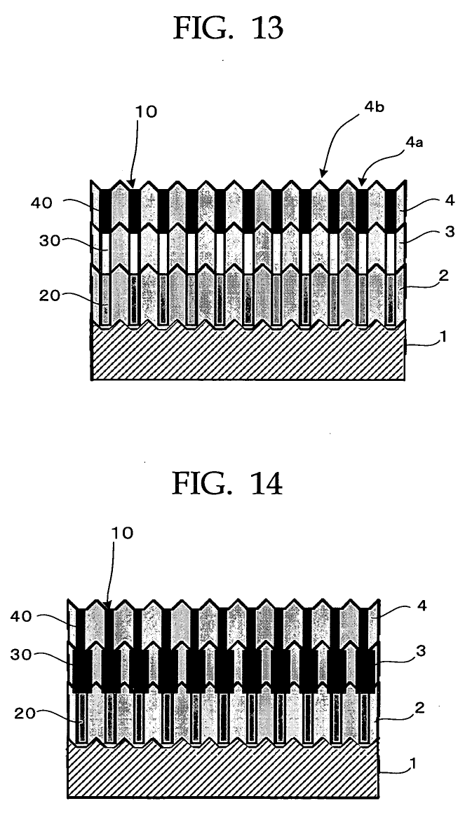

Next, the third metal layer is formed on the second insulating layer 3, to which the step for surface treatment has been performed, as shown in FIG. 13. The third metal layer exhibits a concavoconvex surface owing to the concavoconvex surface of the second insulating layer 3. Then, the third metal layer is subjected to the step for forming nanoholes such as anodization as shown in FIG. 13, thereby many nanoholes 10 are formed in a direction perpendicular to the surface of the substrate 1 while the metal layer being transformed into the insulating layer. The nanoholes 10 are formed at the concave portions of the surface of the third insulating layer 4. These procedures correspond to the third step for forming nanoholes.

Then, the material of the nanopillars are filled or deposited into the nanoholes 10 as shown in FIG. 13, thereby metal nanopillars 40 are produced that is formed of the material of the metal nanopillars described above. These procedures correspond to the third step for forming metal nanopillars.

The surface of the insulating layer 3, within which metal nanopillars 40 have been formed, is subjected to a polishing step to flatten and smoothen, thereby a laminate structure may be obtained with a smooth surface.

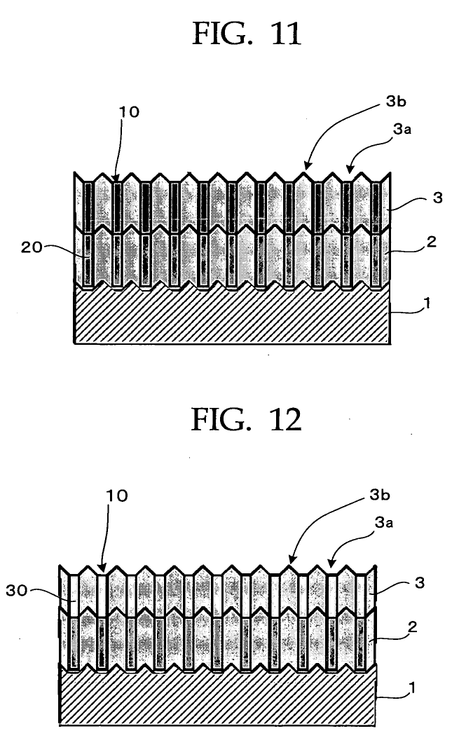

In the example shown in FIGS. 8 to 13, the metal nanopillars 20 and 30 are of substantially the same diameter, contact each other, and are formed approximately at the same sites; these relation are similar to metal nanopillars 30 and 40. In the resultant laminate structure, the length and diameter of the metal nanopillars 20, 30, and 40 are substantially uniform owing to the surface treatment, thus properties derived from the metal nanopillars 20, 30, and 40 are substantially uniform and constant.

The diameter or aperture size of the nanoholes 10 may be enlarged by use of dilute oxalic acid at or after the anodization. By way of enlarging the diameter or aperture size of the nanoholes 10 within the second insulating layer 3 using the dilute oxalic acid, metal nanopillars 30 with larger diameter are formed at the second insulating layer 3 compared to the first and the third insulating layers as shown in FIG. 14.

(Magnetic Recording Medium)

The magnetic recording medium comprises the laminate structure of the present invention described above and other members selected optionally depending on requirements on a substrate, in which the metal nanopillars formed of a magnetic material extend in a direction approximately perpendicular to the surface of the substrate. Namely, the magnetic recording medium of the present invention comprises on the substrate the laminate structure and other members selected optionally depending on requirements, in which the laminate structure comprises plural insulating layers in a laminated condition, each of the insulating layers is penetrated by a number of metal nanopillars having approximately the same length, and the metal nanopillars are arranged in a direction approximately perpendicular to the surface of the substrate.

The laminate structure is appropriately exemplified by one according to the present invention.

The thickness of the respective insulating layers within the laminate structure may be properly selected depending on the application, preferably the thickness is 500 nm or less, more preferably 5 nm to 200 nm.

In the insulating layer of the laminate structure, metal nanopillars are formed. Preferably, the metal nanopillars are formed of a magnetic material, thus the metal nanopillars within the insulating layer may make the insulating layer a magnetic layer by virtue of such configuration.

The magnetic layer may be properly selected depending on the application; for example, the magnetic layer is a ferromagnetic layer or a soft-magnetic layer. Preferably, in the laminate structure, the metal nanopillars in the respective insulating layers forms a soft-magnetic layer and a ferromagnetic layer in this order from the side of the substrate, and also an optional nonmagnetic or intermediate layer is included depending on requirements. In other words, preferably, the metal nanopillars within the insulating layer proximal to the substrate is of a soft-magnetic material, and another metal nanopillars within the insulating layer distal to the substrate is of a ferromagnetic material, with respect to adjacent insulating layers in the laminate structure. Preferably, the metal nanopillars contact each other between the adjacent insulating layers.

Preferably, the thickness of the insulating layer distal to the substrate is one-third to three times the minimum bit length defined by the linear recording density used at recording, and the thickness of the insulating layer distal to the substrate is no more than the thickness of the insulating layer proximal to the substrate.

A soft-magnetic underlayer may exist between the substrate and the insulating layer proximal to the substrate. In such a configuration, preferably, the thickness of the insulating layer distal to the substrate is no more than the total thickness of the insulating layer proximal to the substrate and the soft-magnetic underlayer.

The shape, structure, size, and material of the substrate may be properly selected depending on the application. The substrate preferably has a disk shape when the magnetic recording medium is a magnetic disk such as a hard disk. The structure may be a single layer structure or a multilayer structure. The material can be selected from conventional materials for substrates of magnetic recording media and can be, for example, aluminum, glass, silicon, quartz, or SiO₂/Si (silicon comprising thermal oxide film thereon). These materials may be used alone or in combination. The substrate may be prepared in situ or a commercially available product.

The ferromagnetic layer performs as a recording layer in the magnetic recording medium and constitutes magnetic layers together with the soft-magnetic layer. The ferromagnetic layer in the present invention may be formed from the metal nanopillars within the laminate structure.

The material of the ferromagnetic layer may be properly selected from conventional ones; examples thereof include Fe, Co, Ni, FeCo, FeNi, CoNi, CoNiP, FePt, CoPt and NiPt. These materials may be used alone or in combination.

The thickness of the ferromagnetic layer may be properly selected depending on the linear recording density etc. unless significant adverse effect on the present invention. For example, the thickness is preferably (1) no more than the thickness of the soft-magnetic layer; (2) one-third to three times the minimum bit length defined by the linear recording density utilized at recording; or (3) no more than the total thickness of the soft-magnetic layer and the soft-magnetic underlayer. Specifically, the thickness of the ferromagnetic layer is preferably 5 nm to 100 nm, and more preferably 5 nm to 50 nm. When magnetic recording is performed at a linear recording density of 1,500 kBPI and with a target density of 1 Tb/in², the thickness is preferably 50 nm or less, more preferably approximately 20 nm.

The thickness of the “ferromagnetic layer” means a total of individual ferromagnetic layers when the ferromagnetic layer comprises plural continuous layers or plural separated layers, for example, in the case where the ferromagnetic layer is partitioned by one or more intermediate layers such as nonmagnetic layers and constitutes discontinuous separated ferromagnetic layers. The thickness of the “soft-magnetic layer” means a total thickness of individual soft-magnetic layers when the soft-magnetic layer comprises plural continuous layers or plural separated layers, for example, in the case where the soft-magnetic layer is partitioned by one or more intermediate layers such as nonmagnetic layers and constitutes discontinuous soft-magnetic layers. The “total thickness of the soft-magnetic layer and the soft-magnetic underlayer” means a total of individual soft-magnetic layer and soft-magnetic underlayer when at least one of the soft-magnetic layer and the soft-magnetic underlayer comprises plural continuous layers or plural separated layers, for example, in the case where the soft-magnetic layer or the soft-magnetic underlayer is partitioned by one or more intermediate layers such as nonmagnetic layers and constitutes discontinuous soft-magnetic (under) layers.

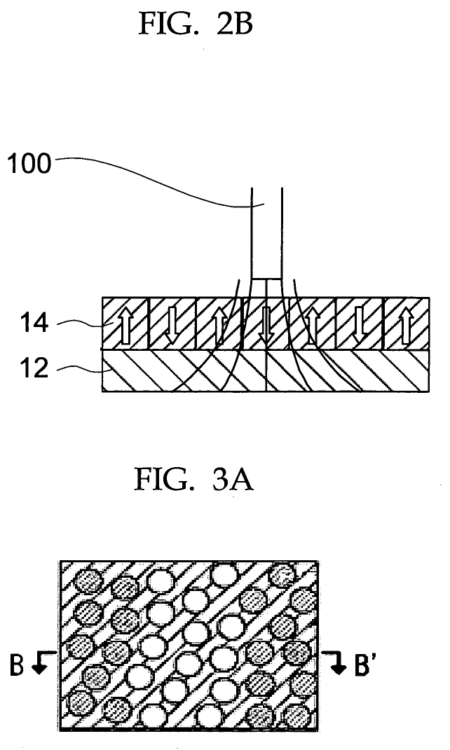

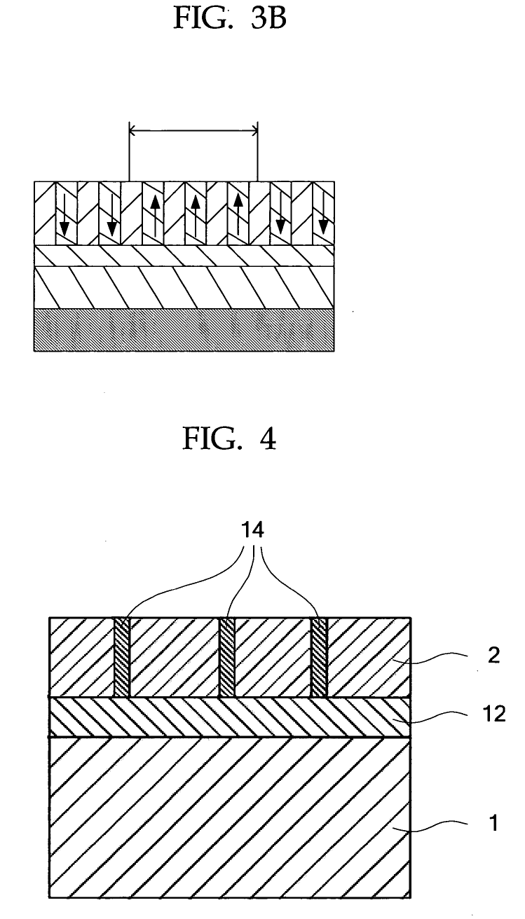

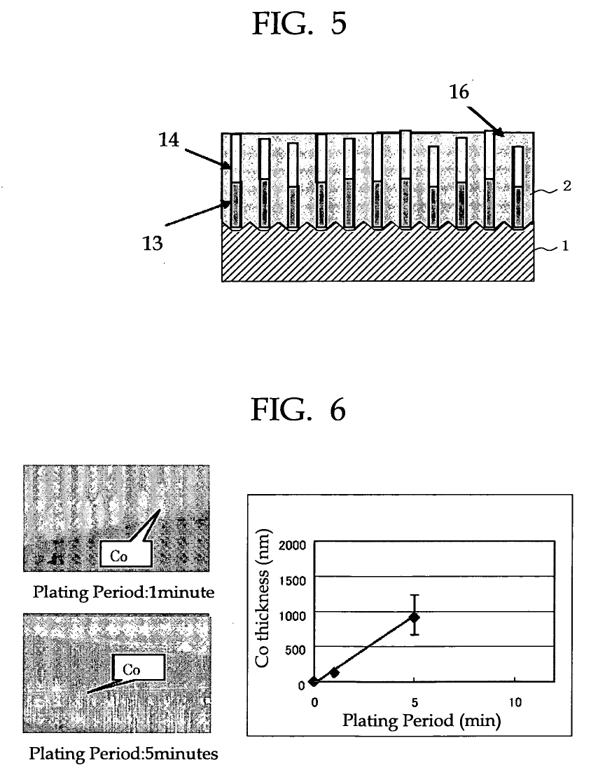

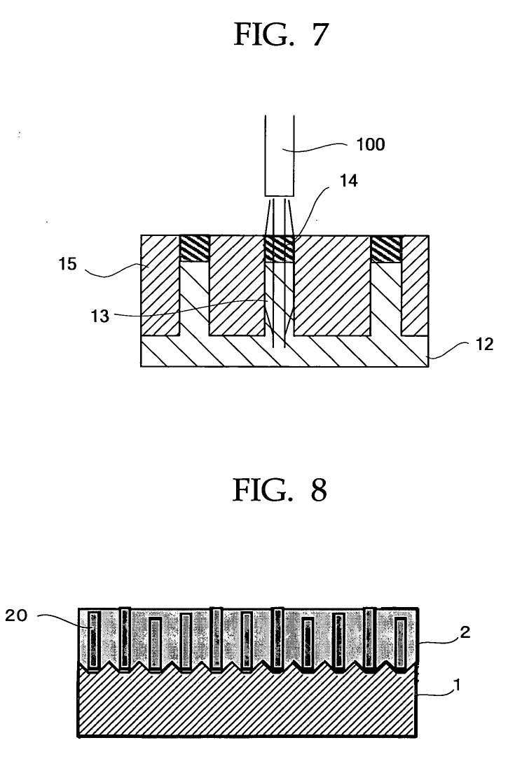

In the embodiment (1) described above, when magnetic recording is performed to the magnetic recording medium using a single magnetic-pole head, only the thickness of the ferromagnetic layer can control the concentration of the magnetic flux from the single magnetic-pole head as well as the optimum magnetic recording-regenerating properties at the employed recording density regardless of the thickness of the laminate structure, since the distance between the single magnetic-pole head and the soft-magnetic layer is shorter than the thickness of the laminate structure and approximately the same with the thickness of the ferromagnetic layer. Further, the magnetic flux from the single magnetic-pole head or write-read head 100 concentrates to the ferromagnetic layer or perpendicularly magnetized film 14 as shown FIG. 2B, consequently, the magnetic recording media may advantageously represent remarkably higher writing efficiency, lower writing current, and remarkably increased overwrite properties, compared to conventional magnetic recording media.

Preferably, the nonuniformity of the thickness of the ferromagnetic layer or recording layer is ±5% or less, more preferably ±2% or less. When the nonuniformity of the thickness of the ferromagnetic layer or recording layer exceeds ±5%, the magnetic recording medium generates significant variation in the saturation magnetization (tBr) and the anisotropy field (Hd), resulting in possible cause of noise.

The nonuniformity of the thickness of the ferromagnetic layer or recording layer may be evaluated from observation of the cross section by means of SEM or TEM.

In the magnetic recording medium of the present invention, the distance between the single magnetic-pole head and the soft-magnetic layer, utilized at the magnetic recording, can be made shorter than the thickness of the laminate structure and approximately the same with the thickness of the ferromagnetic layer, and further the nonuniformity of the thickness can be substantially eliminated from the ferromagnetic layer and the soft-magnetic layer. Accordingly, only the thickness of the ferromagnetic layer can control the concentration of the magnetic flux from the single magnetic-pole head as well as the optimum magnetic recording-regenerating properties at the employed recording density regardless of the thickness of the laminate structure. Consequently, the magnetic recording media may advantageously represent remarkably higher writing efficiency, lower writing current, remarkably increased overwrite properties, lowered noise, and higher thermalfluctuation resistance compared to conventional magnetic recording media.

When variation is significant with respect to the thickness (t) of the ferromagnetic layer or recording layer, i.e. the length or height of the metal nanopillars in the magnetic recording medium, there appears variation in the saturation magnetization (tBr).

Consequently, variation generates in the output of signal magnetic field from the magnetic recording medium, thus variation occurs in the read-head output, resulting in lowered yield. In the magnetic recording media of the present invention, the length or height of the metal nanopillars that perform as the ferromagnetic layer or recording layer is substantially constant and uniform, the saturation magnetization (tBr) may be free from variation, the read-head output may also be free from nonuniformity, thus high quality may be attained.

When the thickness (t) of the ferromagnetic layer or recording layer, i.e. the length or height of the metal nanopillars, fluctuates in the magnetic recording medium, the recording layer changes the shape such as aspect ratio, thus the anisotropy field (Hd) due to shape anisotropy fluctuates. Consequently, the magnetic recording medium generate fluctuation in the coercive force (Hc), possibly resulting in the deterioration of writing yield.

Incidentally, the anisotropy field (Hd) is expressed by the following equation (see “Physics of Ferromagnetic Material (first volume)” p. 13, by Soushin Chikasumi):
Hd=N·I/μ₀
wherein, N: demagnetization factor, I: magnetization intensity, μ₀: space permeability

Assuming that N is a shape factor and the ferromagnetic layer or recording layer is formed of elongated columns, the relation between the aspect ratio (length/diameter) and N is as follows, for example:
aspect ratio (length/diameter)=1 N=0.27
aspect ratio (length/diameter)=2 N=0.14
aspect ratio (length/diameter)=5 N=0.04

In the magnetic recording media of the present invention, the length or height of the metal nanopillars that perform as the ferromagnetic layer or recording layer is substantially constant and uniform, the anisotropy field (Hd) may be free from variation, the yield in writing may be far from degradation, and high quality may be attained.

The soft-magnetic layer in the present invention may be formed of the metal nanopillars of the laminate structure.

The soft-magnetic layer may be properly formed from conventional substances; examples thereof include NiFe, FeSiAl, FeC, FeCoB, FeCoNiB, and CoZrNb. These substances may be used alone or in combination.

The thickness of the soft-magnetic layer may be properly selected within a range unless significant adverse effect on the present invention and may be determined depending on the depth of nanoholes in the porous layer and the thickness of the ferromagnetic layer. For example, (1) the thickness of the soft-magnetic layer may be larger than the thickness of the ferromagnetic layer, or (2) the total thickness of the soft-magnetic layer and the soft-magnetic underlayer may be larger than the thickness of the ferromagnetic layer.

The soft-magnetic layer may effectively converge the magnetic flux from the magnetic head in magnetic recording to the ferromagnetic layer thereby to increase advantageously the vertical component of magnetic field of the magnetic head. The soft-magnetic layer as well as the soft-magnetic underlayer may appropriately constitute a magnetic circuit of recording magnetic field supplied from the magnetic head.

Preferably, the soft-magnetic layer has an easy-magnetization axis in a direction substantially perpendicular to the substrate plane. Thus, in magnetic recording using a head for vertical magnetic recording, the convergence of a magnetic flux from the head for vertical magnetic recording and the optimum properties for magnetic recording and reproduction at a recording density in practice can be controlled and the magnetic flux converges to the ferromagnetic layer. As a result, the magnetic recording media exhibit significantly increased write efficiency, require a decreased write current, and have markedly improved overwrite properties as compared with conventional ones.

In the present invention, a nonmagnetic layer or intermediate layer may further exist between the ferromagnetic layer and the soft-magnetic layer. The intermediate layer may be formed from the metal nanopillars. The nonmagnetic layer or intermediate layer performs to reduce the action of an exchange coupling force between the ferromagnetic layer and the soft-magnetic layer to control and adjust the reproduction properties in magnetic recording at desired levels, when the reproduction properties in the magnetic recording are different from the desired levels.

The material for the nonmagnetic layer may be properly selected from conventional ones; examples thereof include Cu, Al, Cr, Pt, W, Nb, Ru, Ta, and Ti. These materials may be used alone or in combination. The thickness of the nonmagnetic layer may be properly selected depending on the application.

The magnetic recording media of the present invention may further comprise a soft-magnetic underlayer between the substrate and the laminate structure.

The material of the soft-magnetic underlayer may be properly selected from conventional ones, for example, from those exemplified as the materials for the soft-magnetic layer. These materials may be used alone or in combination. The material of the soft-magnetic underlayer may be the same as or different from that of the soft-magnetic layer.

Preferably, the soft-magnetic underlayer possesses an easy-magnetization axis along an in-plane direction of the substrate. In such a construction, magnetic flux from the magnetic head for recording effectively closes to form a magnetic circuit, thereby enabling to increase the vertical component of the magnetic field of the magnetic head. The soft-magnetic underlayer may effectively be employed even in single-domain recording at a bit size or aperture diameter of the nanoholes of 100 nm or less.

The soft magnetic underlayer may be formed by a conventional method such as electrodeposition process or electroless plating process.

The magnetic recording media may further comprise one or more other layers depending on the application; example thereof is an electrode layer, protective layer etc.

The electrode layer performs as an electrode in the formation of the magnetic layer, i.e. the ferromagnetic layer and soft-magnetic layer, by way of electrodeposition etc. and is typically arranged on the substrate and under the ferromagnetic layer. In the step for forming the magnetic layer by electrodeposition, the soft-magnetic underlayer etc. may be utilized as the electrode rather than the electrode layer.

The material of the electrode layer may be properly selected depending on the application; example thereof include Cr, Co, Pt, Cu, Ir, Rh, and alloys thereof. These materials may be used alone or in combination. The electrode layer may comprise other substances such as W, Nb, Ti, Ta, Si and O in addition to the aforementioned materials.

The thickness of the electrode layer may be properly selected depending on the application. The magnetic recording media may comprise one or more of such electrode layers. The electrode layer may be formed by conventional methods such as sputtering and vapor deposition.

The protective layer performs to protect the ferromagnetic layer and is arranged on or above the ferromagnetic layer. The magnetic recording media may comprise one or more of such protective layers which have a single-layer structure or multilayer structure.

The protective layer may be formed from properly selected materials depending on the application, such as diamond-like carbon (DLC).

The thickness of the protective layer may be properly selected depending on the application. The protective layer may be formed by a properly selected conventional process such as plasma CVD or coating.

Preferably, the magnetic recording media of the present invention have a flat surface. The step for smoothening the surface of the magnetic recording media may be polishing of the surface of the magnetic recording media.

The magnetic recording media of the present invention may be applied to various magnetic recording by a magnetic head, preferably to magnetic recording by a single magnetic-pole head, in particular to magnetic recording devices and methods described later.

The magnetic recording media of the present invention can perform high-density recording and high-velocity recording with higher capacity without increasing write current at magnetic heads, and can exhibit excellent overwrite properties, uniform properties, lower noise, superior thermalfluctuation resistance, and higher quality. Accordingly, the magnetic recording media may be designed and utilized as various magnetic recording media, for example, may be designed and utilized as hard disk devices utilized commercially in various products such as external memory devices of computers and recording devices of public videos, and also may be preferably designed and utilized as magnetic disks such as hard disks in particular.

The magnetic recording media of the present invention may be produced by conventional methods selected properly, preferably by the method for producing the magnetic recording medium of the present invention described as follows.

(Method for Producing Magnetic Recording Medium)

The method for producing a magnetic recording medium of the present invention may produce the recording media of the present invention, and comprises a step for forming nanoholes, a step for forming metal nanopillars, a step of surface treatment, a second step for forming nanoholes, a second step for forming metal nanopillars, and the other steps such as a step for forming a soft-magnetic underlayer, a step for forming an electrode layer, a step for forming a nonmagnetic layer, a step for forming a protective layer, and a step of polishing selected properly depending on requirements.

The step for forming nanoholes may be performed in substantially the same manner as the step for forming nanoholes in the method for producing a laminate structure of the present invention described above. The step for forming metal nanopillars may be performed in substantially the same manner as the step for forming metal nanopillars in the method for producing a laminate structure of the present invention described above except that the magnetic material is essential for the metal material. The step of surface treatment may be performed in substantially the same manner as the step of surface treatment in the method for producing a laminate structure of the present invention described above. The second step for forming nanoholes may be performed in substantially the same manner as the second step for forming nanoholes in the method for producing a laminate structure of the present invention described above. The second step for forming metal nanopillars may be performed in substantially the same manner as the second step for forming metal nanopillars in the method for producing a laminate structure of the present invention described above except that the magnetic material is essential for the metal material.

In the step for forming nanoholes, a number of nanoholes are formed within the insulating layer on the substrate while the insulating layer is forming. In the step of forming metal nanopillars, the magnetic material is filled within nanoholes to form metal nanopillars. In the step of surface treatment, the insulating layer into which metal nanopillars have been formed is subjected to surface treatment. In the second step for forming nanoholes, a number of nanoholes are formed within the insulating layer on the above-noted insulating layer after the surface treatment while the insulating layer is forming. In the second step of forming metal nanopillars, the magnetic material is filled within nanoholes to form metal nanopillars.

When two insulating layer exist within the laminate structure in the magnetic recording medium of the present invention, it is preferred that the magnetic material to be filled within the first insulating layer is the soft-magnetic material in the step for forming metal nanopillars and the magnetic material to be filled within the second insulating layer is the ferromagnetic material in the second step for forming metal nanopillars.

— Step for Forming Soft-Magnetic Underlayer —

In the step for forming the soft-magnetic underlayer, the soft-magnetic layer is formed on the substrate prior to the step for forming nanoholes. The step for forming soft-magnetic underlayer may be carried out before the step for forming nanoholes. The substrate may be one described above.

The soft-magnetic underlayer may be formed by conventional methods; examples of the method include sputtering methods, vacuum film-forming methods such as vapor deposition methods, electrodeposition methods, and electroless plating methods. The soft-magnetic underlayer may be formed in an intended thickness on the substrate through the step for forming the soft-magnetic underlayer.

— Step for Forming Electrode Layer —

In the step for forming electrode layer, the electrode layer is formed between the nanohole structure and the soft-magnetic underlayer. The step for forming electrode layer may be carried out prior to the step for forming nanoholes, preferably, after the step for forming soft-magnetic underlayer and before the step for forming nanoholes.

The electrode layer may be formed by conventional methods; examples of the method include sputtering methods and vapor deposition methods. Specific conditions to form the electrode layer may be properly selected depending on the application.

The electrode layer formed in the step for forming electrode layer may be employed as an electrode for forming at least one of the soft-magnetic layer, nonmagnetic layer, and ferromagnetic layer by way of electrodeposition.

— Step for Forming Nonmagnetic Layer —

In the step for forming nonmagnetic layer, the nonmagnetic layer is formed on the soft-magnetic layer. The nonmagnetic layer may be formed substantially in the same manner as the step for forming metal nanopillars; namely, the metal nanopillars may be formed by only the nonmagnetic material of the nonmagnetic layer at the insulating layer laminated on the insulating layer where the soft-magnetic layer is formed as the metal nanopillars, alternatively, the metal nanopillars within an insulating layer may be formed by the material of the metal nanopillars and the nonmagnetic material of the nonmagnetic layer, in the step for forming metal nanopillars, by way of employing the material of the nonmagnetic layer as one metal material for the metal nanopillars.

The step for forming nonmagnetic layer may be carried out by filling or depositing the nonmagnetic material into the nanoholes.

The method for filling or depositing the nonmagnetic material may be properly selected depending on the application; for example, a voltage is applied the electrode of the soft-magnetic underlayer or electrode layer using one or more electrolyte that contains the material of the nonmagnetic layer, thereby to fill or deposit the nonmagnetic material within the nanoholes.

The step for forming nonmagnetic layer may bring about the nonmagnetic layer within the nanoholes above the soft-magnetic layer etc.

— Polishing Step —

In the polishing step, the surface of the uppermost layer of the insulating layer is polished and smoothened after the magnetic layer is formed, i.e. after the metal nanopillars are formed within the outermost insulating layer. When two layers are laminated as the insulating layer, the surface of the second insulating layer is polished and smoothed after the second step for forming metal nanopillars.

The method for polishing in the polishing step may be properly selected from conventional ones without particular limitations. The smoothened surface of the magnetic recording medium after the polishing step may make possible the stable flotation of magnetic heads such as a head for vertical magnetic recording, thus the lowered flotation may advantageously lead to high-density recording as well as higher reliability.

The method for producing a magnetic recording medium of the present invention may provide the magnetic recording medium according to the present invention with higher efficiency and lower cost.

The magnetic recording medium of the present invention and method for producing the same will be explained with reference to figures as follows.

Initially, base 60 is formed on substrate 1, then NiFe is laminated as soft-magnetic underlayer 70 (indicated “SUL(NiFe)” in figures) as shown in FIG. 15. The first metal layer is formed on SUL 70 using a nonmagnetic material such Al.

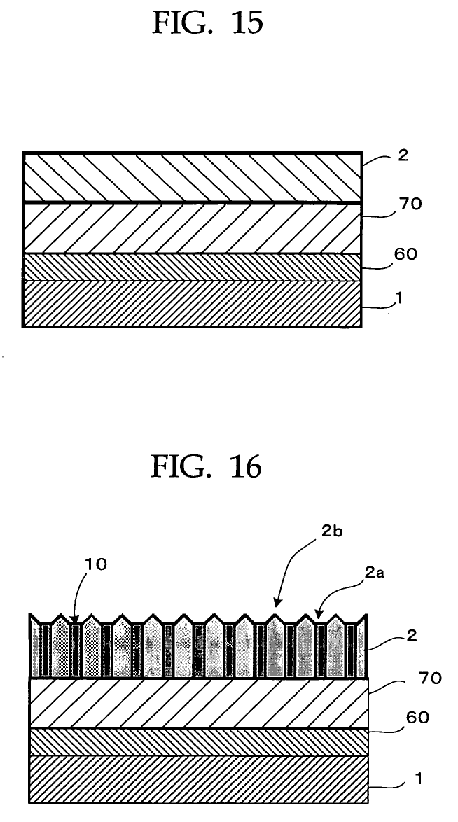

A pattern is formed on the surface of the first metal layer for forming nanoholes 10, the first metal layer is subjected to the nanohole-formation treatment such as anodization, thereby a number of nanoholes 10 of alumina pores are formed in a direction perpendicular to the surface of substrate 1 while the first metal layer is transforming into an insulating layer of alumina as shown in FIG. 16. These procedures correspond to the step for forming nanoholes.

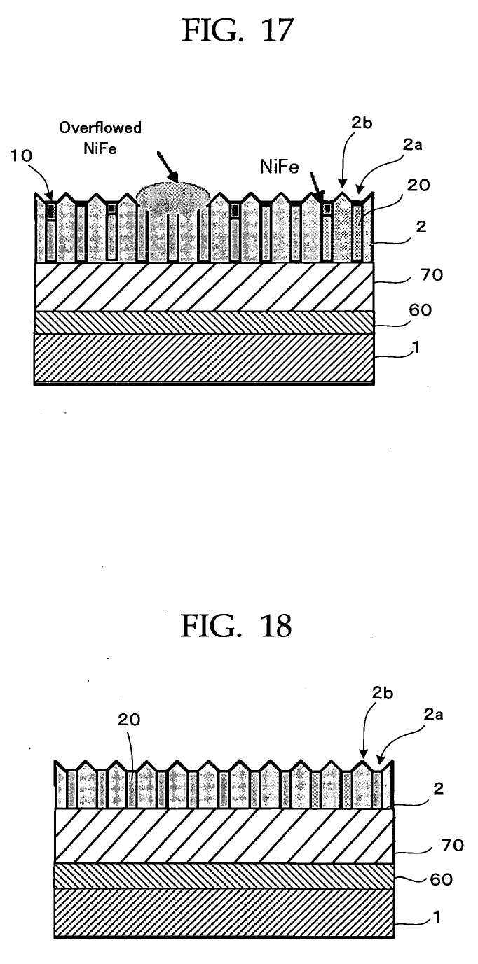

Then, metal nanopillars 20 of the soft-magnetic material are formed by way of filling or depositing the soft-magnetic material NiFe in this case into nanoholes 10 as shown in FIG. 17. These procedures correspond to the step for forming metal nanopillars.

Then, the exposed surface of the insulating layer 2, into which metal nanopillars 20 have been formed, is subjected to the step for surface treatment as shown in FIG. 18. The nonmagnetic material of alumina of the first insulating layer 2 and the soft-magnetic material NiFe of the metal nanopillars 20 typically exhibit different etching rates under identical conditions of etching treatment, therefore, when the etching rate of the material of the metal nanopillars 20 is higher than that of the material of the first insulating layer 2, the metal nanopillars 20 are more depressed than the first insulating layer 2, namely the exposed ends 2a of the metal nanopillars in the first insulating layer 2 represent a concave condition and exist more closely to the substrate 1 than the adjacent insulating parts 2b as shown in FIG. 18. These procedures correspond to the step for surface treatment. The step for surface treatment may make substantially constant the length or height of the metal nanopillars 20 of NiFe that perform as the soft-magnetic layer. Consequently, the resultant magnetic recording medium may exhibit lowered-noise property and superior thermaffluctuation resistance.

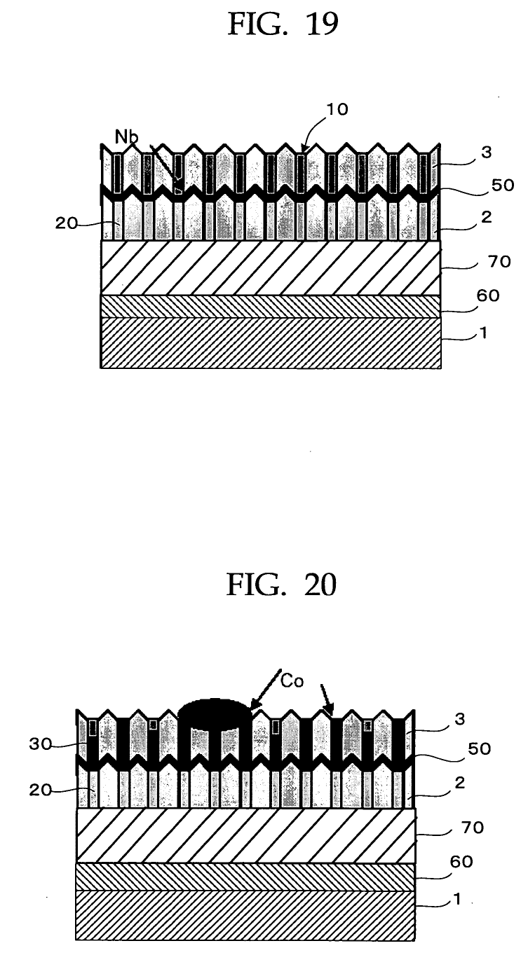

Next, intermediate layer 50 of Nb is formed on the first insulating layer 2 to which the step for surface treatment has been performed, as shown in FIG. 19. The intermediate layer 50 exhibits a concavoconvex surface owing to the concavoconvex surface of the first insulating layer 2. Then, the second metal layer of the nonmagnetic material such as aluminum is formed on the intermediate layer 50 of Nb. The second metal layer exhibits a concavoconvex surface owing to the concavoconvex surface of the intermediate layer 50. Then, the second metal layer is subjected to the step for forming nanoholes such as anodization, thereby many nanoholes 10 are formed while the second metal layer being transformed into the insulating layer of alumina. In the step for forming the nanoholes, the second insulating layer 3 is eroded gradually from the exposed surface toward the substrate 1. The erosion ceases at the other end where intermediate layer 50 exists, since the intermediate layer 50 of Nb is etching-resistant thereby the formation of nanoholes 10 is inhibited at the intermediate layer 50. As such, the formation of nanoholes leaves no excessive etching on the surface of the first insulating layer 2. These procedures correspond to the second step for forming nanoholes.

Then, metal nanopillars 30 of cobalt (Co) of the ferromagnetic material are formed within many nanoholes 10 formed at the second insulating layer 3 by way of filling or depositing through a plating process, electrodeposition etc. as shown in FIG. 20. These procedures correspond to the step for forming the second metal nanopillars.

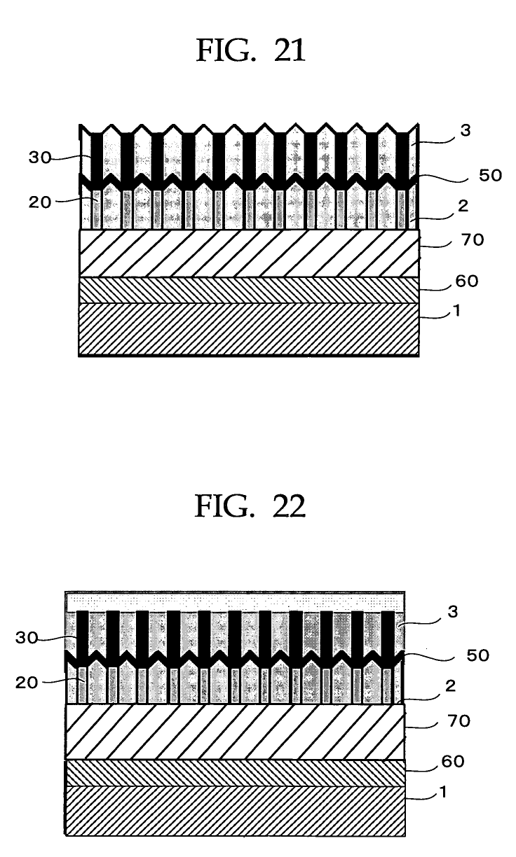

The exposed surface of the insulating layer 3, into which metal nanopillars 30 have been formed, is subjected to a polishing step to flatten and smoothen, thereby a magnetic recording medium may be obtained with a smooth surface as shown in FIG. 21. In the example shown in FIGS. 15 to 21, the metal nanopillars 20 and 30 are of substantially the same diameter, contact each other, and are formed approximately at the same sites. In the resultant magnetic recording medium, the metal nanopillars 20 of Co, which are formed into a single-domain structure and perform as a ferromagnetic layer, and the underlying metal nanopillars 30 of NiFe, which perform as a soft-magnetic layer, are substantially uniform and fine in their length and diameter, in contrast to those obtained by conventional methods.

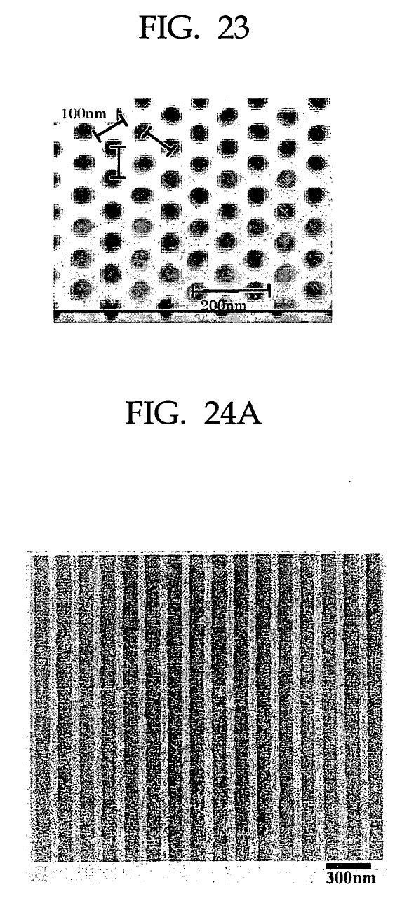

In the resultant magnetic recording medium of the present invention, many metal nanopillars 30 of ferromagnetic material Co exist at the surface region in a direction approximately perpendicular to substrate 1 as shown in FIG. 23. The magnetic recording medium may be utilized as a patterned medium of single-domain structure rather than complex-domain structure. For example, when the magnetic recording medium is recorded by means of a head for vertical magnetic recording, only the thickness of the metal nanopillars 30 of the ferromagnetic layer may control the concentration of magnetic flux from the head for vertical magnetic recording, optimum properties of magnetic recording and regeneration etc. at the used recording density, regardless of the total thickness of the first insulating layer 2 and the second insulating layer 3, since the distance between the head for vertical magnetic recording and soft-magnetic underlayer 70 is shorter than the total thickness of the first insulating layer 2 and the second insulating layer 3, and approximately the same as the thickness, length, or height of the metal nanopillars 30 of the ferromagnetic layer. In this case, the magnetic flux from the single magnetic-pole head or read-write head 100 concentrates to the ferromagnetic layer or vertical magnetizing film 14, consequently, write efficiency is improved remarkably, writing current is reduced, high-density recording and high-velocity recording are possible, capacity is increased, overwrite properties are improved, properties are more uniform, noise is lowered, thermalfluctuation resistance is superior, and the quality is improved compared to the conventional magnetic recording devices.

(Magnetic Recording Device and Magnetic Recording Method)

The magnetic recording device of the present invention comprises the magnetic recording medium of the present invention and a head for vertical magnetic recording and may further comprise one or more other means or members depending on requirements.

The magnetic recording method according to the present invention comprises recording on the magnetic recording medium of the present invention using a head for vertical magnetic recording and may further comprise one or more other steps or treatments depending on requirements. The magnetic recording method is preferably carried out using the magnetic recording device of the present invention. The other steps or treatments can be carried out using the other means or members. The magnetic recording device as well as the magnetic recording method will be illustrated below.

The head for vertical magnetic recording may be properly selected depending on the application; preferable example thereof is a single magnetic-pole head. The head for vertical magnetic recording may be a write-only head or read-write head integrated with a read head such as a giant magneto-resistive (GMR) head.

In the magnetic recording device or the magnetic recording method, the magnetic recording medium of the present invention is employed. Thus, the distance between the head for vertical magnetic recording and the soft-magnetic layer in the magnetic recording medium is shorter than the total thickness of the first insulating layer and the second insulating layer, and is substantially equal to the thickness of the ferromagnetic layer; accordingly, the convergence of a magnetic flux from the head for vertical magnetic recording and the optimum properties for magnetic recording and reproduction at a recording density in practice can be controlled only by controlling the thickness of the ferromagnetic layer, regardless of the thickness of the insulating layers. As shown in FIG. 2B, the magnetic flux from a main pole of the head for vertical magnetic recording or read-write head 100 converges to the ferromagnetic layer or perpendicularly magnetized film 14. As a result, the magnetic recording device exhibits significantly increased write efficiency, markedly improved overwrite properties, decreased write current, lowered noise, and superior thermalfluctuation resistance, as compared with conventional equivalents.

Preferably, the magnetic recording medium further comprises the soft-magnetic underlayer for. higher recording density, because the head for vertical magnetic recording and the soft-magnetic underlayer constitute a magnetic circuit in the construction. The construction may advantageously make possible high-density recording.

In the magnetic recording by means of the magnetic recording device or the magnetic recording method of the present invention, the magnetic flux from the head for vertical magnetic recording is free from divergence and tends to converge on the ferromagnetic layer in the magnetic recording medium even at the bottom thereof, i.e., at the interface with the soft-magnetic layer or the nonmagnetic layer, therefore, information can be recorded in small bits.

The degree of convergence or divergence of the magnetic flux may be properly selected in the ferromagnetic layer depending on the application unless significant adverse effects on the present invention.

(Element)

The element of the present invention comprises the laminate structure of the present invention and other means and/or members properly selected depending on the application.

The specific examples of the element according to the present invention may be nonvolatile memories; giant magneto resistance elements such as read-only heads for HDD and magnetic sensors; spin valve films, tunnel effect films, various sensors such as biosensors and gas sensors; displays such as field effect displays and MRAM; optical elements, and the like.

The nonvolatile memories may be properly selected depending on the application; examples thereof include phase-change memories.

— Phase-Change Memory —

The phase-change memories or phase-change semiconductor memories are those capable of storing information by utilizing phase change i.e. change of substance condition, reading and writing by use of electric signals, and rewriting in nonvolatile state.

The phase-change memories are recorded by use of the resistivity difference in the phase-change film between the amorphous and crystalline conditions; for example, are actuated such that “0” state is recognized at a crystalline condition of lower resistivity and “1” state is recognized at an amorphous condition of higher resistivity on the ground that the phase-change substance changes into the crystalline or amorphous conditions due to the temperature difference derived by electric currents.

In the case that an element of the present invention is employed as the phase-change memory, the laminate structure may be made into the phase-change memory by forming the metal nanopillars of the laminate structure with the material of the phase-change film.

The phase-change memory comprises electrodes 80 as lower terminals, insulating layer 2, and insulating layer 3 on substrate 1 in this order, as shown in FIG. 29. In insulating layer 2, metal nanopillars 20 are formed that performs as heating elements. In insulating layer 3, metal nanopillars 32 having a larger diameter are formed that perform as the memory sites and are formed of chalcogenide GeSbTe film. Upper terminals 82 are formed on the chalcogenide film. The phase-change memory is one of laminate structures according to the present invention.

In the phase-change memory, the phase of the chalcogenide GeSbTe film is changed by metal nanopillars 20 that perform as heating elements. Since the phase-change memory is formed from the laminate structure of the present invention, the cell size may be reduced, the contacting area may be reduced between the heating element of metal nanopillar 20 and the memory element of the chalcogenide GeSbTe film, and the writing current may be lowered. Further, since the terminal resistances and contacting areas corresponding to the sizes and thicknesses of respective layers are substantially equalized in the phase-change memory, bit errors may be reduced and the power consumption may be lowered.

The method for producing the nonvolatile memory of the phase change memory will be explained with reference to figures in the following.

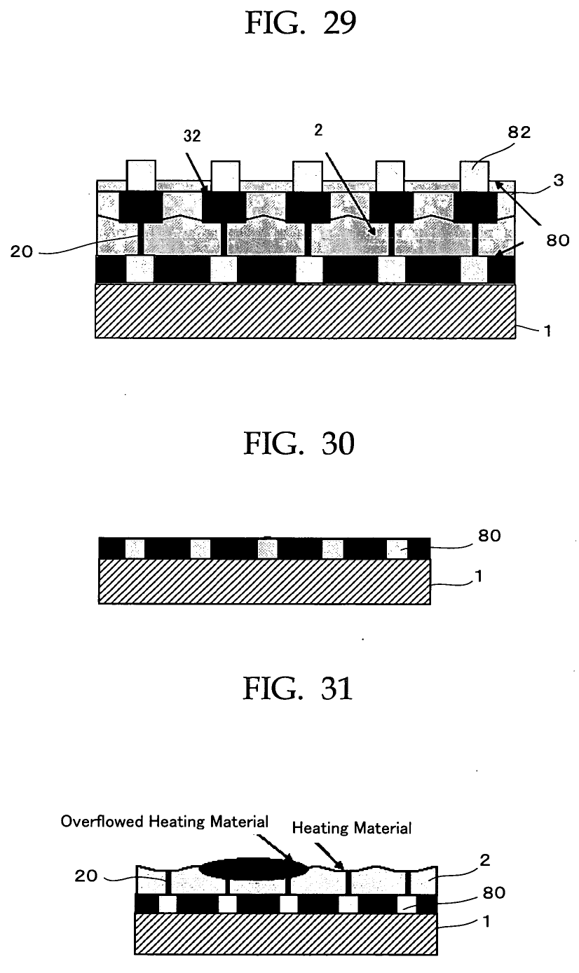

Initially, lower electrodes or terminals 80 are laminated on substrate 1 as shown in FIG. 30, then the first metal layer of aluminum is formed on the lower electrodes 80 as shown in FIG. 31. A pattern is formed on the surface of the first metal layer for forming nanoholes 10, then the first metal layer is subjected to the nanohole-formation treatment such as anodization, thereby a number of nanoholes 10 of alumina pores are formed in a direction perpendicular to the surface of the substrate 1 while the first metal layer is transforming into an insulating layer of alumina as shown in FIG. 31. These procedures correspond to the step for forming nanoholes. Then, metal nanopillars 20 of the heating element material of W or Mo are formed by way of filling or depositing the heating element material of W or Mo into nanoholes 10 as shown in FIG. 31. These procedures correspond to the step for forming metal nanopillars.

Then, the exposed surface of the insulating layer 2, into which metal nanopillars 20 have been formed, is subjected to the step for surface treatment. The nonmagnetic material of alumina of the first insulating layer 2 and the heating element material of W or Mo of the metal nanopillars 20 typically exhibit different etching rates under identical conditions of etching treatment, therefore, when the etching rate of the heating element material of W or Mo of the metal nanopillars 20 is higher than that of the material of the first insulating layer 2, the metal nanopillars 20 are more depressed than the first insulating layer 2, namely the exposed ends 2a of the metal nanopillars in the first insulating layer 2 represent a concave condition and exist more closely to the substrate 1 than the adjacent insulating parts 2b. These procedures correspond to the step for surface treatment. The step for surface treatment may make substantially constant the length or height of the metal nanopillars 20 of W or Mo that perform as the heating elements.

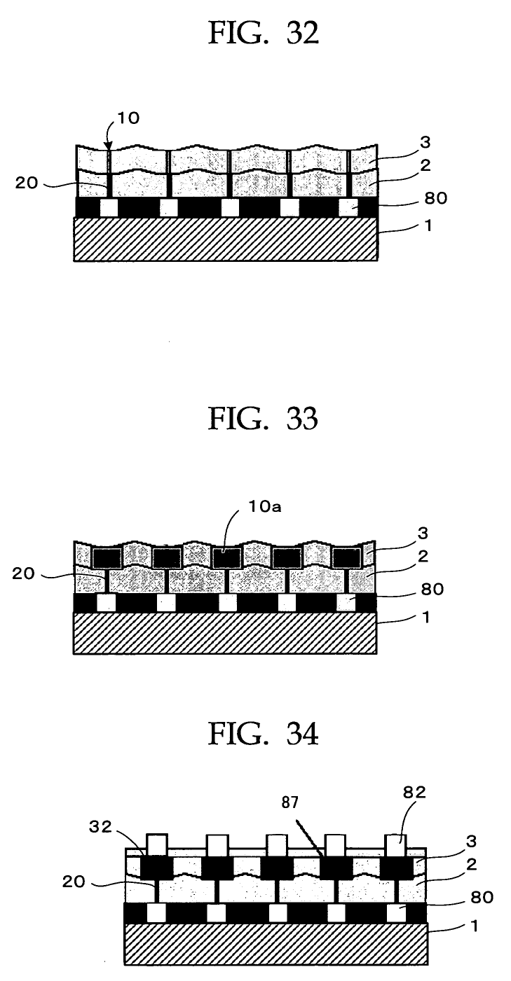

Next, the second metal layer of Al is formed on the first insulating layer 2 to which the step for surface treatment has been performed, as shown in FIG. 32. The second metal layer exhibits a concavoconvex surface owing to the concavoconvex surface of the first insulating layer 2. Then, the second metal layer is subjected to the step for forming nanoholes such as anodization, thereby many nanoholes 10 are formed while the metal layer being transformed into the insulating layer of alumina. In the step for forming the nanoholes, the aperture diameter of the nanoholes 10 is enlarged by use of oxalic acid as shown in FIG. 33. These procedures correspond to the second step for forming nanoholes.

Then, the chalcogenide GeSbTe film of a memory element material is formed within many nanoholes 10a having an enlarged diameter formed at the second insulating layer 3 by way of filling or depositing through a plating process, electrodeposition, etc as shown in FIG. 33, thereby metal nanopillars 30 of the chalcogenide GeSbTe film are formed. These procedures correspond to the step for forming the second metal nanopillars.

The exposed surface of the insulating layer 3, into which metal nanopillars 30 have been formed, is subjected to a polishing step to flatten and smoothen, thereby a phase-change memory may be obtained with a smooth surface as shown in FIG. 34. In the example shown in FIG. 34, the metal nanopillars 20 and 30 contact each other, and are formed approximately at the same sites.

Since the terminal resistances and contacting areas corresponding to the sizes and thicknesses of respective layers are substantially equalized in the resultant nonvolatile or phase-change memory of the present invention, bit errors may be reduced and the power consumption may be lowered.

— Giant Magneto Resistance Element and Spin Valve Film —

The giant magneto resistance (GMR) element involves a spin valve element or membrane at the head, and the spin valve element is a thin film of such a configuration that a nonmagnetic layer is put between ferromagnetic layers to form a sandwich of a magnetic layer, a nonmagnetic layer, and a magnetic layer. The change of magnetization direction in one magnetic layer, so-called free layer, may lead to an effect of the giant magneto resistance in which electric resistance differs depending on the magnetization direction of parallel or reverse within the two magnetic layers due to the different scattering of the conduction electrons. The giant magneto resistance (GMR) element is an element that utilizes the physical phenomenon of magneto resistance effect, more specifically, is one of magneto resistance elements in which the element senses the time-variable magnetic energy and outputs as the change of resistance.

The preferable configuration of the magnetic head of hard disks that utilizes spin valve films capable of the giant magneto resistance is exemplified by the configuration that involves a regenerating head for reading change in magnetic field from a recording medium by the spin valve film and a recording head that records by generating magnetic field owing to flowing current through a coil.

A specific example of the spin valve film involves the upper NiFe permalloy layer that performs as a free layer responsive to external magnetic field and lower Co layer that performs as a spin layer in which magnetization direction is fixed by exchange coupling with antiferromagnetic MnPt. The spin valve film may definitely change the flow direction of current i.e. the spin direction at the free layer into the reverse direction of 180 degrees. When a magnetic field is applied to the spin valve film from zero magnetic field to a minus direction, the magnetization is stable at a minus value of about half of the saturation value till a certain level of the magnetic field, and when the magnetization directions of the two ferromagnetic layers are reverse and the magnetizations of the both magnetic layers are reverse, a rapid increase of electric resistance appears in the electric resistance of the element, therefore, the spin valve film may be utilized as an element having a remarkably high sensitivity to magnetic field.

The giant magneto resistance (GMR) element is read-only, thus when the element is utilized as a HDD magnetic head for personal computers, a writing inductive head of electromagnetic induction type may be combined.

In a case that the element of the present invention is utilized as a giant magneto resistance (GMR) element, the laminate structure may be formed into the giant magneto resistance (GMR) element by way of constructing a sandwich configuration of the magnetic layer, the nonmagnetic layer, and the magnetic layer, using the metal nanopillars of the laminate structure.

When the element of the present invention is utilized as the giant magneto resistance (GMR) element, the GMR element may exhibit less fluctuation in anisotropic magnetic field (Hua), MR ratio, resistivity etc. and higher quality since the sandwich configuration of the magnetic layer, the nonmagnetic layer, and the magnetic layer are constructed by use of the metal nanopillars with an approximately constant length or thickness.

The specific example of the GMR element of multilayer type will be explained with reference to figures.

The GMR element of the first multilayer type comprises, lower electrode 80 on the substrate 1, laminate 100 on the lower electrode, and upper electrode 80 on the laminate 100 as shown in FIG. 35, in which laminate 100 comprises repeatedly laminated plural insulating layers where many nanopillars of cobalt (Co) are formed and plural insulating layers where many nanopillars of copper (Cu) are formed.

Within the laminate 100, metal nanopillars of cobalt (Co) and metal nanopillars of copper (Cu) contact each other and exist approximately at same sites with a same size. Accordingly, the condition is similar to that many metal nanopillars, each of which being formed of plural nanopillars of Co and Cu, are formed in the direction perpendicular to the surface of substrate 1.

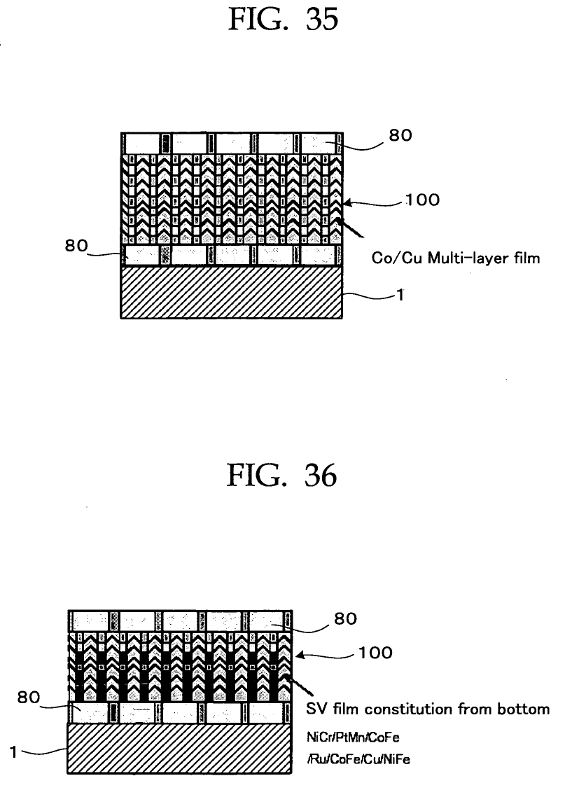

The GMR element of the second multilayer type comprises, lower electrode 80 on the substrate 1, laminate 100 on the lower electrode, and upper electrode 80 on the laminate 100 as shown in FIG. 36, in which laminate 100 comprises an insulating layer where many nanopillars of NiCr are formed, an insulating layer where many nanopillars of PtMn are formed, an insulating layer where many nanopillars of CoFe are formed, an insulating layer where many nanopillars of Ru are formed, an insulating layer where many nanopillars of CoFe are formed, an insulating layer where many nanopillars of Cu are formed, and an insulating layer where many nanopillars of NiFe are formed.

Within laminate 100, metal nanopillars of NiCr, metal nanopillars of PtMn, metal nanopillars of CoFe, metal nanopillars of Ru, metal nanopillars of CoFe, metal nanopillars of Cu, and metal nanopillars of NiFe contact in this order, and are formed approximately at same sites with a same size.

The method for producing the GMR element of multilayer type according to the present invention will be explained with reference to figures as follows.

Initially, lower electrodes or terminals 80 are laminated by means of a photolithography process etc. on substrate 1 as shown in FIG. 36, then the first metal layer of aluminum is formed on the lower electrodes 80. A pattern is formed on the surface of the first metal layer for forming nanoholes 10, then the first metal layer is subjected to the nanohole-formation treatment such as anodization, thereby a number of nanoholes 10 of alumina pores are formed in a direction perpendicular to the surface of the substrate 1 while the first metal layer is transforming into an insulating layer. These procedures correspond to the step for forming nanoholes. Then, many metal nanopillars 20 of NiCr are formed by way of filling or depositing the heating element material of NiCr into nanoholes 10. These procedures correspond to the step for forming metal nanopillars.

Then, the exposed surface of the insulating layer 2, into which metal nanopillars 20 have been formed, is subjected to the step for surface treatment; thereby, the metal nanopillars 20 are more depressed than the insulating layer 2. These procedures correspond to the step for surface treatment. The step for surface treatment may make substantially constant the length or height of the metal nanopillars 20 of NiCr.

Next, the second metal layer of Al is formed on the first insulating layer 2 to which the step for surface treatment has been performed. The second metal layer exhibits a concavoconvex surface owing to the concavoconvex surface of the first insulating layer 2. Then, the second metal layer is subjected to the step for forming nanoholes such as anodization, thereby many nanoholes 10 are formed while the metal layer being transformed into the insulating layer of alumina. These procedures correspond to the second step for forming the nanoholes.

Then, PtMn is filled or deposited into nanoholes 10 formed within the second insulating layer 3 by a plating process, electrodeposition process etc., thereby many metal nanopillars 30 of PtMn are formed. These procedures correspond to the second step for forming metal nanopillars.

Then, the exposed surface of the insulating layer 3, into which metal nanopillars 30 have been formed, is subjected to the step for surface treatment; thereby, the metal nanopillars 30 are more depressed than the insulating layer 3. These procedures correspond to the step for surface treatment. The step for surface treatment may make substantially constant the length or height of the metal nanopillars 30 of PtMn.

Next, the third metal layer of Al is formed on the second insulating layer 3 to which the step for surface treatment has been performed. The third metal layer exhibits a concavoconvex surface owing to the concavoconvex surface of the second insulating layer 3. Then, the third metal layer is subjected to the step for forming nanoholes such as anodization, thereby many nanoholes 10 are formed while the metal layer being transformed into the insulating layer of alumina. These procedures correspond to the third step for forming the nanoholes.

Then, CoFe is filled or deposited into nanoholes 10 formed within the third insulating layer 4 by a plating process, electrodeposition process etc., thereby many metal nanopillars 40 of CoFe are formed. These procedures correspond to the third step for forming metal nanopillars.

Then, the exposed surface of the insulating layer 4, into which metal nanopillars 40 have been formed, is subjected to the step for surface treatment; thereby, the metal nanopillars 40 are more depressed than the insulating layer 4. These procedures correspond to the step for surface treatment. The step for surface treatment may make substantially constant the length or height of the many metal nanopillars 40 of CoFe.

Next, the fourth metal layer of Al is formed on the third insulating layer 4 to which the step for surface treatment has been performed. The fourth metal layer exhibits a concavoconvex surface owing to the concavoconvex surface of the third insulating layer 4. Then, the fourth metal layer is subjected to the step for forming nanoholes such as anodization, thereby many nanoholes 10 are formed while the fourth metal layer being transformed into the fourth insulating layer of alumina. These procedures correspond to the fourth step for forming the nanoholes.

Then, Ru is filled or deposited into nanoholes 10 formed within the fourth insulating layer by a plating process, electrodeposition process etc., thereby many metal nanopillars of Ru are formed. These procedures correspond to the fourth step for forming metal nanopillars.

Then, the exposed surface of the insulating layer, into which metal nanopillars have been formed, is subjected to the step for surface treatment; thereby, the metal nanopillars are more depressed than the insulating layer. These procedures correspond to the step for surface treatment. The step for surface treatment may make substantially constant the length or height of the many metal nanopillars 40 of Ru.

Next, the fifth metal layer of Al is formed on the fourth insulating layer to which the step for surface treatment has been performed. The fifth metal layer exhibits a concavoconvex surface owing to the concavoconvex surface of the fourth insulating layer. Then, the fifth metal layer is subjected to the step for forming nanoholes such as anodization, thereby many nanoholes 10 are formed while the fifth metal layer being transformed into the fifth insulating layer of alumina. These procedures correspond to the fifth step for forming the nanoholes.

Then, CoFe is filled or deposited into nanoholes 10 formed within the fifth insulating layer by a plating process, electrodeposition process etc., thereby many metal nanopillars of CoFe are formed. These procedures correspond to the fifth step for forming metal nanopillars.

Then, the exposed surface of the insulating layer, into which metal nanopillars have been formed, is subjected to the step for surface treatment; thereby, the metal nanopillars are more depressed than the insulating layer. These procedures correspond to the step for surface treatment. The step for surface treatment may make substantially constant the length or height of the many metal nanopillars of CoFe.

Next, the sixth metal layer of Al is formed on the fifth insulating layer to which the step for surface treatment has been performed. The sixth metal layer exhibits a concavoconvex surface owing to the concavoconvex surface of the fifth insulating layer. Then, the sixth metal layer is subjected to the step for forming nanoholes such as anodization, thereby many nanoholes 10 are formed. These procedures correspond to the sixth step for forming the nanoholes.

Then, Cu is filled or deposited into nanoholes 10 formed within the sixth insulating layer by a plating process, electrodeposition process etc, thereby many metal nanopillars of Cu are formed. These procedures correspond to the sixth step for forming metal nanopillars.

Then, the exposed surface of the insulating layer, into which metal nanopillars have been formed, is subjected to the step for surface treatment; thereby, the metal nanopillars are more depressed than the insulating layer. These procedures correspond to the step for surface treatment. The step for surface treatment may make substantially constant the length or height of the many metal nanopillars of Cu.

Next, the seventh metal layer of Al is formed on the sixth insulating layer to which the step for surface treatment has been performed. The seventh metal layer exhibits a concavoconvex surface owing to the concavoconvex surface of the sixth insulating layer. Then, the seventh metal layer is subjected to the step for forming nanoholes such as anodization, thereby many nanoholes 10 are formed while the seventh metal layer being transformed into the seventh insulating layer of alumina. These procedures correspond to the seventh step for forming the nanoholes.

Then, NiFe is filled or deposited into nanoholes 10 formed within the seventh insulating layer by a plating process, electrodeposition process etc., thereby many metal nanopillars of NiFe are formed. These procedures correspond to the seventh step for forming metal nanopillars.

Then, the exposed surface of the insulating layer, into which metal nanopillars have been formed, is subjected to the polishing to smoothen and flatten, thereby the GMR element of multilayer type shown in FIG. 36 is obtained.

— Tunnel Effect Film —

The tunnel effect film refers to the film that comprises the insulating film as the nonmagnetic layer and that utilizes tunneling magnetoresistance (TMR) such that tunneling current varies and the resistivity remarkably changes depending on the magnetization direction of the ferromagnetic layer.

The tunnel effect film has a construction that a thin insulating material is interposed between two ferromagnetic layers (referred to as “tunnel connection”). When a voltage is applied between the two layers of the tunnel effect film, electrons travel through the insulating material and an electric current flows owing to the tunneling magnetoresistance of a quantum mechanics effect. The level of the current depends on the relative direction of the magnetization of the two ferromagnetic layers. When the magnetization directions are parallel, the current flows more easily i.e. the resistance decreases, and when the magnetization directions are reverse each other, the current flows more hardly i.e. the resistance increases.

The element of the present invention may be utilized as the tunnel effect film.

Hereinafter, the present invention will be described specifically by way of Examples, but it should be understood that the present invention is not limited thereto. In the Examples, the magnetic recording medium of the present invention that comprises the laminate structure of the present invention is produced by the method of the present invention, and is magnetic-recorded by the magnetic recording device of the present invention, and the magnetic recording method of the present invention is carried out. Further, the element of the present invention comprising the laminate structure of the present invention is demonstrated.

### EXAMPLE 1

<Preparation of Magnetic Recording Medium>

— Process for Forming Soft-Magnetic Underlayer —

As shown in FIG. 15, cohesive base 60 of Ta was formed on substrate 1 by a sputtering process to 5 nm thick, then soft-magnetic underlayer 70 of NiFe was overlapped by a sputtering process to 20 nm thick.

— Preparation of Nanohole —

Then, a first metal layer of aluminum of nonmagnetic material was formed on the soft-magnetic underlayer 70 by a sputtering process to 200 nm thick.

The imprint-transfer mold was produced as follows that was utilized for forming nanoholes of concavoconvex pattern on the surface of the first metal layer. By means of Deep UV-ray apparatus of wavelength 257 nm for preparing optical disk stampers, a dot pattern was drawn circumferentially on a resist layer of 40 nm thick spin-coated on a glass substrate, thereby to form a concavoconvex pattern. The space or pitch of the concave lines of the concavoconvex pattern was approximately 1 mm and the depth of the concave lines was approximately 40 nm in the concavoconvex pattern. A Ni layer was formed on the respective concavoconvex shapes by a sputtering process, then by use of the Ni layer as an electrode and a nickel sulfamate bath, a Ni stamper mold was produced by way of electroforming a Ni layer to 0.3 mm thick and polishing the back side thereof.

The resultant Ni stamper mold was pressed onto the surface of the first metal layer, thereby the concavoconvex pattern formed on the surface of the Ni stamper mold was imprint-transferred onto the surface of the first metal layer. The first metal layer was of 5 N purity, and the surface had been smoothened previously by electropolishing. The pressure at the imprint-transfer was 3,000 kg/cm².

Then, the first metal layer after the imprint-transfer was subjected to anodization for forming nanoholes using a dilute phosphoric acid of concentration 0.3 mol/L at the bath temperature 20° C., thereby nanoholes were formed while the first metal layer was transforming into insulating layer 2 of alumina, as shown in FIG. 16. The voltage at the anodization was controlled to the value of [(space of nanoholes (nm))÷2.5 (nm/V)] i.e. 40 V in this example. The anodization resulted in many nanoholes of alumina pores of approximately 50 nm diameter in the insulating layer 2 as shown in the SEM image of FIG. 23. The pitch of the nanoholes was approximately 100 nm.

— Process for Forming Metal Nanopillar —

Next, metal nanopillars 20 of NiFe were formed by way of filling or depositing NiFe of soft-magnetic material onto nanoholes 10 through a plating process by use of a plating bath at 35° C. containing ferrous sulfate, nickel sulfide, boric acid and the like as shown in FIG. 17. These procedures corresponded to the step for forming metal nanopillars.

— Process for Surface Treatment —

Next, the exposed surface of insulating layer 2, where metal nanopillars 20 being formed, was subjected to a surface treatment such that alumina convexes at nanohole apertures were rough-polished by a milling process then the exposed surface was chemically-mechanically polished by use of a polishing tape of 0.3 μm alumina grain. The surface treatment brought about depression or concave of metal nanopillars 20 since the etching rate of the NiFe of metal nanopillars was higher than that of the alumina under the same conditions on the first insulating layer 2. These procedures corresponded to the step for surface treatment. The surface treatment yielded substantially uniform height or length of approximately 100 nm with respect to metal nanopillars 20 of NiFe. The thickness of the porous alumina layer was approximately 100 nm, and the aspect ratio of the nanoholes or alumina pores filled with NiFe was approximately 2.0 after the polishing process.

— Process for Forming Intermediate Layer —

Next, Nb intermediate layer 50 of approximately 5 nm thick was formed on the first insulating layer 2 by a sputtering process after the surface treatment process as shown in FIG. 19. The resultant intermediate layer 50 exhibited a concavoconvex surface owing to the concavoconvex surface of the first insulating layer 2.

— Process for Forming Second Nanoholes —

Thereafter, the second metal layer of aluminum was formed to 200 nm thick on the intermediate layer 50 of Nb by a sputtering process. The third metal layer exhibited a concavoconvex surface owing to the concavoconvex surface of the second insulating layer 3. Then, the second metal layer was subjected to anodization for forming nanoholes, thereby the second metal layer was transformed into the second insulating layer 3 of alumina and nanoholes were generated. The voltage at the anodization was controlled to the value of [(space of nanoholes (nm))÷2.5 (nm/V)] i.e. 40 V in this example. In the step for forming the nanoholes, the second insulating layer was eroded gradually from the exposed surface toward the substrate 1. The erosion ceased at the other end of the second insulating layer where intermediate layer 50 existed, since the intermediate layer 50 of Nb was etching-resistant thereby the formation of nanoholes was inhibited at the intermediate layer 50. As such, the formation of nanoholes left no excessive etching on the surface of the first insulating layer 2. The anodization provided many nanoholes of alumina pores of approximately 50 nm diameter at the second insulating layer 3 as shown in SEM image of FIG. 23. The pitch of the nanoholes was approximately 100 nm. These procedures corresponded to the second step for forming nanoholes.

— Formation of Second Metal Nanopillar —

Then, metal nanopillars 30 of cobalt (Co) were formed as shown in FIG. 20 by way of filling or depositing Co through a plating process into many nanoholes 10 formed at the second insulating layer 3 as shown in FIG. 21. These procedures corresponded to the second step for forming the metal nanopillars.

— Polishing Process —

The overflowed Co layer and the alumite pore layer were subjected to a chemical-mechanical polishing. The Co layer remained in a thickness of 150 nm. Similarly to the NiFe layer, the Co layer showed a substantially equivalent thickness over the entire substrate, and represented magnetic anisotropy in the vertical direction to substrate 1 due to the shape anisotropy. Finally, the surface was smoothened by a lower-angle milling process, and perfluoropolyether (lubricant AM3001, by Solvay Solexis Co.) was coated on the polished magnetic disk by a dipping process to obtain a magnetic recording medium.

In the resultant magnetic recording medium, as shown in FIG. 21, the shape factors such as length and diameter were substantially uniform and fine in terms of the metal nanopillars 20 of Co that were formed into single-domain structure and perform as a ferromagnetic layer as well as in terms of the underlying metal nanopillars 30 of NiFe that performed as a soft-magnetic layer.

In the magnetic recording medium of Example 1, many metal nanopillars 30 of ferromagnetic material Co exist at the surface region in a direction approximately perpendicular to substrate 1, as shown in FIG. 23. The magnetic recording medium may be utilized as a patterned medium of single-domain structure rather than complex-domain structure. For example, when the magnetic recording medium is recorded by means of a head for vertical magnetic recording, only the thickness of the metal nanopillars 30 of the ferromagnetic layer may control the concentration of magnetic flux from the head for vertical magnetic recording, optimum properties of magnetic recording and regeneration at the employed recording density, and the like, regardless of the total thickness of the first insulating layer 2 and the second insulating layer 3, since the distance between the head for vertical magnetic recording and soft-magnetic underlayer 70 is shorter than the total thickness of the first insulating layer 2 and the second insulating layer 3, and approximately the same as the thickness, length, or height of the metal nanopillars 30 of the ferromagnetic layer. In this case, the magnetic flux from the single magnetic-pole head or read-write head 100 concentrates to the ferromagnetic layer or vertical magnetizing film 14, consequently, write efficiency is improved remarkably, writing current is reduced, high-density recording and high-velocity recording are realized, capacity is increased, overwrite properties are improved, properties are more uniform, and the quality is improved compared to the conventional magnetic recording devices.

The magnetic properties of the magnetic recording medium prepared in Example 1 were evaluated by means of a magnetic head described below i.e. so-called magnetic head of merge type that combines single magnetic-pole write head for vertical recording and GMR read head. The head parameters are as follows.
Write core width: 60 nm
Write pole length: 50 nm
Read core width: 50 nm
Read gap length: 60 nm

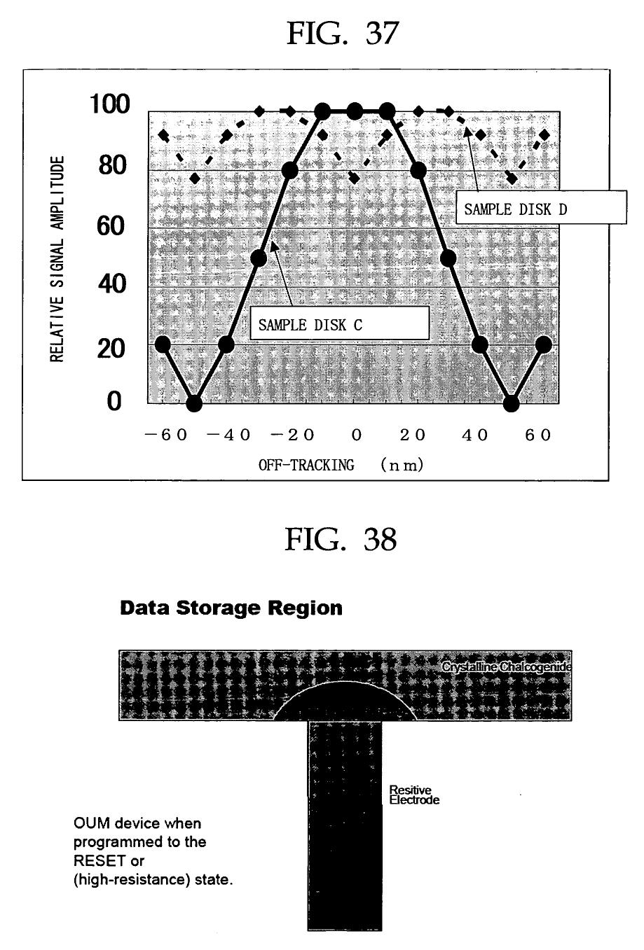

Initially, the signal amplitude was determined while causing off-track in a read condition in terms of the magnetic recording medium of sample disk C in Example 1 and the magnetic recording medium of sample disk D in Comparative Example 1 in which the magnetic layer was formed from a layer rather than dots. The results are shown in FIG. 37.

From FIG. 37, it was confirmed that off-track lead to rapid decrease of the signal amplitude and signals are substantially separable completely between tracks with respect to the magnetic recording medium of sample disk C in Example 1 where magnetic dots are aligned on one track and nonmagnetic region separates respective tracks. On the contrary, it was confirmed that off-track scarcely bring about the decrease of signal amplitude and the signals are non-separable between tracks with respect to the magnetic recording medium of sample disk D in Comparative Example 1 where the magnetic dots are aligned two-dimensionally.

These results demonstrate that the magnetic recording medium or magnetic disk of Example 1 may achieve high-density tracks and also may lead to read the magnetic dots in circumferential direction with sufficient separating property, thus high density recording may be attained such that recording and regeneration are possible for one bit per one dot.

Further, the magnetic recording medium of Example 1 and the magnetic recording medium of Comparative Example 1, prepared in the same manner as Example 1 except that the surface treatment was not conducted, were evaluated. The respective magnetic recording media were subjected to magnetic recording of writing by use of the single magnetic-pole head and readout by use of the GMR head by means of a magnetic recording device equipped with the single magnetic-pole head of writing magnetic head and the GMR head of readout magnetic head, then the saturation magnetization (tBr) and anisotropy field of the medium were determined.

The magnetic recording medium of Comparative Example 1 exhibited significant fluctuation in the saturation magnetization (tBr), which resulted in the fluctuation of signal magnetic field outputted from the magnetic recording medium, therefore the output of the read head fluctuated, resulting in lower yield rate. In addition, the thickness (t) of the ferromagnetic layer or the recording layer fluctuated significantly, which brought about the variation of length or height of the metal nanopillars and the nonuniformity of shape such as aspect ratios in the recording layer, resulting in fluctuation of anisotropy field (Hd) due to the anisotropy shape, thus the coercive force (Hc) of the magnetic recording medium fluctuated and the writing yield decreased.

On the other hand, the magnetic recording medium of the present invention represented substantially uniform and constant length or height in the metal nanopillars for the ferromagnetic layer or recording layer, therefore could provide less fluctuation in the saturation magnetization (tBr), less possibility in the variation of the read-head output, less fluctuation in the anisotropy field (Hd), less possibility of decrease in the writing yield, and could assure high quality.

The magnetic recording medium of Example 1 exhibited superior saturation magnetization (tBr) and anisotropy field (Hd) compared to the magnetic recording medium of Comparative Example 1 that was prepared in the same manner as Example 1 but without the surface treatment process.

### EXAMPLE 2

<Preparation of Phase-Change Memory>

Initially, lower electrode or lower terminal 80 was laminated on substrate 1 by way of a photolithography process as shown in FIG. 30, then a first metal layer of aluminum was formed on the lower electrode 80 to 200 nm thick by a sputtering process as shown in FIG. 31. Then, the first metal layer was subjected to anodization for forming nanoholes using a dilute phosphoric acid of concentration 0.3 mol/L at bath temperature 20° C., thereby the first metal layer was transformed into an insulating layer of alumina and nanoholes were formed. The voltage at the anodization was controlled to the value of [(space of nanoholes (nm))÷2.5 (nm/V)] i.e. 160 V in this example. The anodization resulted in many nanoholes of alumina pores of approximately 150 nm diameter in the insulating layer 2. The pitch of the nanoholes was approximately 400 nm. These procedures corresponded to the step for forming the nanoholes.

Then, metal nanopillars 20 of W were formed by way of filling or depositing W metal for heating elements into nanoholes 10 through a spattering process as shown in FIG. 31. These procedures corresponded to the step for forming the metal nanopillars.

Next, the exposed surface of insulating layer 2, where W metal nanopillars 20 being formed, was subjected to a surface treatment such that alumina convexes at nanohole apertures were rough-polished by a milling process then the exposed surface was chemically-mechanically polished by use of a polishing tape of 0.3 μm alumina grain. After the procedures, the metal nanopillars 20 were depressed more deeply than insulating layer 2 and the exposed ends were situated more closely to the substrate 1 than the adjacent insulating parts, since the alumina of the first insulating layer 2 and W metal of the metal nanopillars 20 exhibited different etching rates under identical etching conditions, i.e. W material of the heating element displayed higher etching rate than that of the alumina of the first insulating layer 2. These procedures corresponded to the step for surface treatment. The surface treatment resulted in substantially uniform height or length of W metal nanopillars 20.

Next, an aluminum second metal layer of approximately 200 nm thick was formed on the first insulating layer 2 by a sputtering process after the surface treatment process. The resultant second metal layer exhibited a concavoconvex surface owing to the concavoconvex surface of the first insulating layer 2.

Then, the second metal layer was subjected to anodization for forming nanoholes using a dilute phosphoric acid of concentration 0.3 mol/L at bath temperature 20° C., thereby the second metal layer was transformed into an insulating layer of alumina and nanoholes were formed. The voltage at the anodization was controlled to the value of [(space of nanoholes (nm))÷2.5 (nm/V)] i.e. 160 V in this example. The anodization resulted in many nanoholes of alumina pores of approximately 150 nm diameter in the insulating layer 3. The pitch of the nanoholes was approximately 400 nm. Then, the aperture diameter of nanoholes 10 was enlarged into 300 nm by use of oxalic acid as shown in FIG. 33. These procedures corresponded to the second step for forming nanoholes.

Next, a chalcogenide film of GeSbTe of memory element material 87 was filled or deposited through a plating process and also GeSbTe was filled or deposited through a CVD process onto the many large-sized nanoholes formed in the second insulating layer 3 as shown in FIG. 33. Consequently, metal nanopillars of chalcogenide film of GeSbTe were provided. These procedures corresponded to the second step for forming the metal nanopillars.

The exposed surface of the insulating layer 3, in which metal nanopillars were formed, was subjected to smoothened and flattened through a polishing process, thereby a phase-change memory with a flat surface was obtained as shown in FIG. 34. In the Example shown in FIG. 34, metal nanopillars 20 and were formed at approximately the same sites and contacted each other.

Using the resultant phase-change memory of Example 2, current was directed to lower electrode 80, and W metal nanopillars 20 as the heating element were heated. The heat from the heating element induced the phase change of the metal nanopillars formed of GeSbTe chalcogenide film of memory element material, disposed adjacent to the heating element, from amorphous to crystalline states. Further, the change was recognized between the state of “1” where the resistance was higher and the phase was amorphous and the state of “0” where the resistance was lower and the phase was crystalline, which demonstrated the possibility for the phase-change memory.

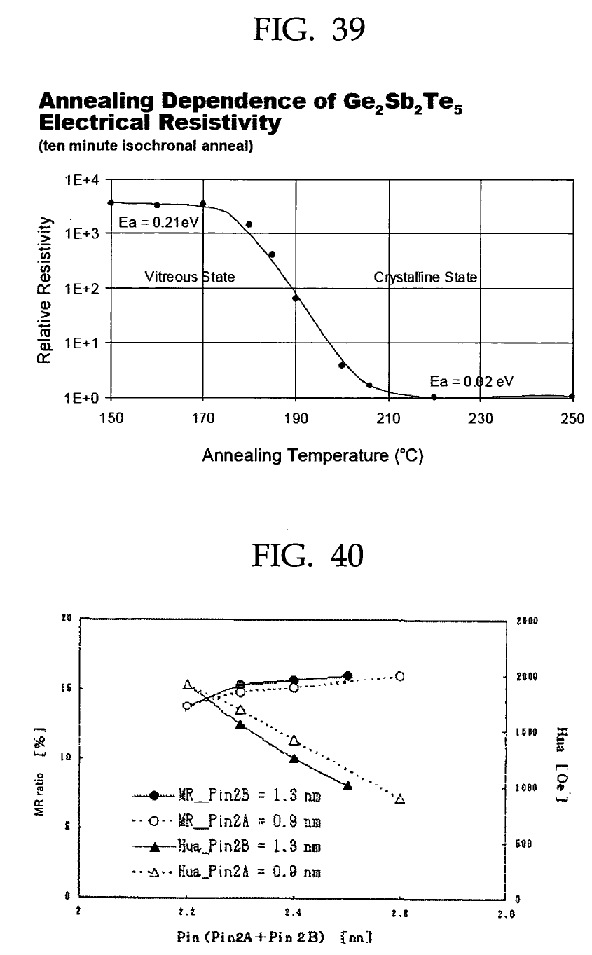

FIG. 38 is an exemplary enlarged cross section showing the schematic condition of the W metal nanopillar 20 of the heating element and the GeSbTe chalcogenide film of the memory element material that contact each other. FIG. 39 is a graph that shows the relation between the relative resistivity of the GeSbTe chalcogenide film of the memory element material and the heating temperature. The graph shows that higher heating temperature leads to phase change of the GeSbTe chalcogenide film from amorphous to crystalline, resulting in the decrease of the resistivity.

In the phase-change memory, the phase change of the GeSbTe chalcogenide layer of the memory element material is typically carried out by heat from the adjacent heater. Accordingly, the fluctuation of heat quantity at the respective heating elements adjacent to the respective memory elements inevitably leads to the fluctuation of the resistivity values of the respective memory elements, consequently, the period for reading the memory comes to longer. On the contrary, in the phase-change memory as Example 2, the heat quantity at the heating elements directly relates with the diameter and length of the metal nanopillars 20 due to the cylindrical shape the metal nanopillars 20, and the diameter and the length are approximately constant over the respective metal nanopillars 20, as a result, the contacting area may be substantially uniform between the respective heating elements and memory elements and thus the heat quantity at the heating elements may be substantially uniform, thus the terminal resistance may be adjusted substantially constant, the bit errors may be decreased, and the power consumption may also be lowered.

### EXAMPLE 3

<Preparation of Giant Magneto Resistance Element of Multi Layer Type>

Initially, lower electrode 80 or lower terminal was laminated on substrate 1 by way of a photolithography process as shown in FIG. 36, then a first metal layer of aluminum was formed on the lower electrode 80 to 100 nm thick by a sputtering process. Then, the first metal layer was subjected to anodization for forming nanoholes using a dilute phosphoric acid of concentration 0.3 mol/L at bath temperature 20° C., thereby the first metal layer was transformed into a first insulating layer of alumina and nanoholes were formed. The voltage at the anodization was controlled to the value of [(space of nanoholes (nm))÷2.5 (nm/V)] i.e. 40 V in this example. The anodization resulted in many nanoholes of alumina pores of approximately 50 nm diameter in the first metal layer. The pitch of the nanoholes was approximately 100 nm. These procedures corresponded to the step for forming the nanoholes.

Then, metal nanopillars 20 of NiCr were formed by way of filling or depositing NiCr through a plating process at many nanoholes 10 by use of a plating bath containing nickel sulfide at bath temperature 35° C. These procedures corresponded to the step for forming the metal nanopillars.

Next, the exposed surface of insulating layer 2, where metal nanopillars 20 being formed, was subjected to a surface treatment such that alumina convexes at nanohole apertures were rough-polished by a milling process then the exposed surface was chemically-mechanically polished by use of a polishing tape of 0.3 μm alumina grain. After the procedures, the metal nanopillars 20 were depressed more deeply than insulating layer 2 and the exposed ends 2a were situated more closely to the substrate 1 than the adjacent insulating parts 2b, since the alumina of the first insulating layer 2 and NiCr metal of the metal nanopillars 20 exhibited different etching rates under identical etching conditions, i.e. NiCr material of the heating element displayed higher etching rate than that of the alumina of the first insulating layer 2. These procedures corresponded to the step for surface treatment. The surface treatment resulted in substantially uniform height or length of NiCr metal nanopillars 20.

Next, an aluminum second metal layer of approximately 30 nm thick was formed on the first insulating layer 2 by a sputtering process after the surface treatment process. The resultant second metal layer exhibited a concavoconvex surface owing to the concavoconvex surface of the first insulating layer 2.

Then, the second metal layer was subjected to anodization, thereby the second metal layer was transformed into an insulating layer of. alumina and many nanoholes 10 were formed, as described above. These procedures corresponded to the second step for forming nanoholes.

Next, metal nanopillars 30 of PtMn were formed by way of filling or depositing PtMn into nanoholes 10 formed within the second insulating layer 3 through a spattering process. These procedures corresponded to the second step for forming the metal nanopillars.

Next, the exposed surface of insulating layer 3, where metal nanopillars 30 being formed, was subjected to a surface treatment. After the procedures, the metal nanopillars 30 were depressed more deeply than insulating layer 3. These procedures corresponded to the step for surface treatment. The surface treatment resulted in substantially uniform height or length of many metal nanopillars 30 of PtMn.

Next, an aluminum third metal layer of approximately 10 nm thick was formed on the second insulating layer 3 by a sputtering process after the surface treatment process. The resultant third metal layer exhibited a concavoconvex surface owing to the concavoconvex surface of the second insulating layer 3. Then, the third metal layer was subjected to an etching treatment through an anodization process, as described above, thereby the third metal layer was transformed into the third insulating layer of alumina and many nanoholes 10 were formed. These procedures corresponded to the third step for forming nanoholes.

Next, many metal nanopillars 40 of CoFe were formed by way of filling or depositing CoFe into nanoholes 10 formed within the third insulating layer 4 through a spattering process. These procedures corresponded to the third step for forming the metal nanopillars.

Next, the exposed surface of insulating layer 4, where metal nanopillars 40 being formed, was subjected to a surface treatment as described above. After the procedures, the metal nanopillars 40 were depressed more deeply than insulating layer 4. These procedures corresponded to the step for surface treatment. The surface treatment resulted in substantially uniform height or length of many metal nanopillars 40 of CoFe.

Next, an aluminum fourth metal layer of approximately 2 nm thick was formed on the third insulating layer 4 by a sputtering process after the surface treatment process. The resultant fourth metal layer exhibited a concavoconvex surface owing to the concavoconvex surface of the third insulating layer 4. Then, the fourth metal layer was subjected to an etching treatment through an anodization process, as described above, thereby the fourth metal layer was transformed into the insulating layer of alumina and many nanoholes 10 were formed. These procedures corresponded to the fourth step for forming the nanoholes.

Next, many metal nanopillars of Ru were formed by way of filling or depositing Ru into nanoholes 10 formed within the fourth insulating layer through a plating process as described above. These procedures corresponded to the fourth step for forming the metal nanopillars.

Next, the exposed surface of insulating layer, where metal nanopillars being formed, was subjected to a surface treatment. After the procedures, the metal nanopillars were depressed more deeply than insulating layer. These procedures corresponded to the step for surface treatment. The surface treatment resulted in substantially uniform height or length of many metal nanopillars of Ru.

Next, an aluminum fifth metal layer of approximately 10 nm thick was formed on the fourth insulating layer by a sputtering process after the surface treatment process. The resultant fifth metal layer exhibited a concavoconvex surface owing to the concavoconvex surface of the fourth insulating layer. Then, the fifth metal layer was subjected to an etching treatment through an anodization process, as described above, thereby the fifth metal layer was transformed into the insulating layer of alumina and many nanoholes 10 were formed. These procedures corresponded to the fifth step for forming the nanoholes.

Next, metal nanopillars of CoFe were formed by way of filling or depositing CoFe into nanoholes 10 formed within the fifth insulating layer through a spattering process. These procedures corresponded to the fifth step for forming the metal nanopillars.

Next, the exposed surface of insulating layer, where metal nanopillars being formed, was subjected to a surface treatment. After the procedures, the metal nanopillars were depressed more deeply than insulating layer. These procedures corresponded to the step for surface treatment. The surface treatment resulted in substantially uniform height or length of many metal nanopillars of CoFe.

Next, an aluminum sixth metal layer of approximately 3 nm thick was formed on the fifth insulating layer by a sputtering process after the surface treatment process. The resultant sixth metal layer exhibited a concavoconvex surface owing to the concavoconvex surface of the fifth insulating layer. Then, the sixth metal layer was subjected to an etching treatment through an anodization process, as described above, thereby the sixth metal layer was transformed into the insulating layer of alumina and many nanoholes 10 were formed. These procedures corresponded to the sixth step for forming the nanoholes.

Next, metal nanopillars of Cu were formed by way of filling or depositing Cu into nanoholes 10 formed within the sixth insulating layer through a plating process as described above. These procedures corresponded to the sixth step for forming the metal nanopillars.

Next, the exposed surface of insulating layer, where metal nanopillars being formed, was subjected to a surface treatment. After the procedures, the metal nanopillars were depressed more deeply than insulating layer. These procedures corresponded to the step for surface treatment. The surface treatment resulted in substantially uniform height or length of many metal nanopillars of Cu.

Next, an aluminum seventh metal layer of approximately 10 nm thick was formed on the sixth insulating layer by a sputtering process after the surface treatment process. The resultant seventh metal layer exhibited a concavoconvex surface owing to the concavoconvex surface of the sixth insulating layer. Then, the seventh metal layer was subjected to an etching treatment through an anodization process, as described above, thereby the seventh metal layer was transformed into the insulating layer of alumina and many nanoholes 10 were formed. These procedures corresponded to the seventh step for forming the nanoholes.

Next, metal nanopillars of NiFe were formed by way of filling or depositing NiFe into nanoholes 10 formed within the seventh insulating layer through a plating process as described above. These procedures corresponded to the seventh step for forming the metal nanopillars.

The exposed surface of the insulating layer, in which metal nanopillars were formed, was subjected to smoothened and flattened through a polishing process, thereby a GMR element of multilayer type was obtained as shown in FIG. 36.

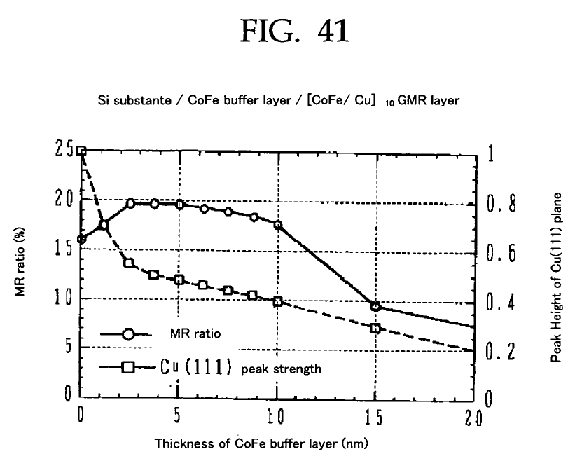

Conventionally, giant magneto resistance elements of spin valve type represent a dependence of isotropy magnetic field (Hua) and MR ratio with pin thickness etc. (see FIG. 40) and those of multilayer type represent a dependence of MR ratio with underlayer thickness etc. (see FIG. 41). However, the giant magneto resistance element of multilayer type of Example 3 has demonstrated that there appear remarkably less isotropy magnetic field (Hua), MR ratio, and resistivity, and thus significantly high quality may be achieved, which is believed due to the fact that the sandwich structure of laminate 100 i.e. magnetic layer/nonmagnetic layer/magnetic layer is formed from metal nanopillars having an approximately identical length and thickness.

The laminate structures according to the present invention may be widely applied to various fields or products such as magnetic recording media, nonvolatile memories, giant magneto resistance elements, spin valve films, tunnel effect films, sensors e.g. DNA tips and diagnostic devices, displays e.g. field emission displays, optical elements, and the like, in particular to hard disk devices utilized commercially in various products such as external memory devices of computers and recording devices of public videos.

The method for producing a laminate structure of the present invention may be properly applied to the production of the laminate structure of the present invention.

The magnetic recording medium of the present invention may be properly applied to hard disk devices utilized commercially in various products such as external memory devices of computers and recording devices of public videos.

The method for producing a magnetic recording medium of the present invention may be properly applied to the production of the magnetic recording medium of the present invention.

The magnetic recording device of the present invention may be properly applied to hard disk devices utilized commercially in various products such as external memory devices of computers and recording devices of public videos.

The magnetic recording method of the present invention may provide high density recording and high velocity recording with higher capacity without increasing write current at magnetic heads, exhibit excellent overwrite property and uniform properties, and may be applied to recordings with higher quality.

The element of the present invention may be properly applied to nonvolatile memories, giant magneto resistance elements, spin valve films, tunnel effect films, various sensors, displays, optical elements, and the like.

The present invention may provide a laminate structure with metal nanopillars, which solves various problems in the prior art, utilized widely in a wide range of fields such as magnetic recording media, nonvolatile memories, giant magneto resistance elements, spin valve films, tunnel effect films, various sensors, displays, and optical elements. The present invention may also provide a magnetic recording medium that is applied to hard disk devices utilized commercially in various products such as external memory devices of computers and recording devices of public videos, wherein the magnetic recording medium can perform high-density recording and high-velocity recording with higher capacity without increasing write current at magnetic heads, and can exhibit excellent overwrite properties, uniform properties, lower noise, superior thermaffluctuation resistance, and higher quality. The present invention may also provide a method for producing the magnetic recording medium with higher efficiency and lower cost. The present invention may also provide a magnetic recording device, which involves the magnetic recording medium in vertical recording, capable of recording with lower noise, superior thermalfluctuation resistance, and high-density recording. The present invention may also provide a method. of magnetic recording. The present invention may also provide an element, which involves the laminate structure and is properly utilized for nonvolatile memories, giant magneto resistance elements, spin valve films, tunnel effect films, various sensors, displays, and optical elements.

What is claimed is:

1. A laminate structure comprising:
a number of metal nanopillars, and
plural insulating layers,
wherein the lengths of the metal nanopillars are approximately equivalent, each of the plural insulating layers is penetrated by the metal nanopillars, and the plural insulating layers are laminated to each other.

2. The laminate structure according to claim 1, wherein the insulating layers are formed of alumina.

3. The laminate structure according to claim 1, wherein a material of the insulating layers exhibits an etching rate different from the etching rate of the material of the metal nanopillars under an identical etching condition.

4. The laminate structure according to claim 1, wherein the material of the metal nanopillars is a magnetic material.

5. The laminate structure according to claim 1, wherein the diameter of the metal nanopillars is 100 nm or less.

6. The laminate structure according to claim 1, wherein the length of the metal nanopillars is 200 nm to 10,000 nm.

7. The laminate structure according to claim 1, wherein the space between the adjacent metal nanopillars is 5 nm to 500 nm.

8. The laminate structure according to claim 1, wherein the sites of the metal nanopillars at an insulating layer are approximately the same as the sites of the metal nanopillars at the adjacent insulating layer, and the metal nanopillars of the insulating layer and the metal nanopillars of the adjacent insulating layer contact each other.

9. The laminate structure according to claim 1, wherein at least one of the material of the metal nanopillars and the material of the insulating layer is the same between adjacent insulating layers.

10. The laminate structure according to claim 1, wherein at least one of the diameter and the length of the metal nanopillars is the same or different in terms of the adjacent insulating layers.

11. The laminate structure according to claim 1, wherein an intermediate layer is disposed between adjacent insulating layers.

12. The laminate structure according to claim 1, wherein the intermediate layer is formed of an insoluble or hardly soluble material under an anodization process.

13. The laminate structure according to claim 1, wherein the metal nanopillars are arranged into one of concentric patterns and spiral patterns.

14. The laminate structure according to claim 1, wherein the metal nanopillars are formed by filling the material of the metal nanopillars into nanoholes formed by anodization of the insulating layer.

15. A magnetic recording medium, comprising:
a substrate, and
a laminate structure on the substrate,
wherein the laminate structure comprises a number of metal nanopillars and plural insulating layers,
the metal nanopillars are formed of a magnetic material, and extend to a direction approximately perpendicular to the surface of the substrate, and the lengths of the metal nanopillars are approximately equivalent, and
each of the plural insulating layers is penetrated by the metal nanopillars, and the plural insulating layers are laminated to each other.

16. The magnetic recording medium according to claim 15,
wherein the plural insulating layers comprise an insulating layer proximal to the substrate and an insulating layer distal to the substrate, and the insulating layer proximal to the substrate and the insulating layer distal to the substrate are adjacent to each other,
the metal nanopillars within the insulating layer proximal to the substrate is formed of a soft-magnetic material,
the metal nanopillars within the insulating layer distal to the substrate is formed of a ferromagnetic material, and
the thickness of the insulating layer distal to the substrate is not more than the thickness of the insulating layer proximal to the substrate.

17. The magnetic recording medium according to claim 16, wherein a soft-magnetic underlayer is disposed between the substrate and the insulating layer proximal to the substrate.

18. The magnetic recording medium according to claim 17, wherein the thickness of the insulating layer distal to the substrate is no more than the total thickness of the insulating layer proximal to the substrate and the soft-magnetic underlayer.

19. The magnetic recording medium according to claim 16, wherein a nonmagnetic layer is disposed between the insulating layer distal to the substrate and the insulating layer proximal to the substrate.

20. An element comprising a laminate structure,
wherein the laminate structure comprises a number of metal nanopillars and plural insulating layers,
the lengths of the metal nanopillars are approximately equivalent, each of the plural insulating layers is penetrated by the metal nanopillars, and the plural insulating layers are laminated to each other.
